(19) United States
(12) Patent Application Publication
(10) Pub. No.: US 2004/0030428 A1
(43) Pub. Date: Feb. 12, 2004

(54) System and method for scheduling and sequencing supply chain resources

(75) Inventors: Myrick D. Crampton, Mt. Pleasant, SC (US); Michael Liu, Germantown, MD (US); Jay Harrison, Mount Airy, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc.

(21) Appl. No.: 10/429,235

(22) Filed: May 5, 2003

Related U.S. Application Data
(60) Provisional application No. 60/377,243, filed on May 3, 2002.
(60) Provisional application No. 60/381,801, filed on May 21, 2002.

(51) Int. Cl. G06F 19/00

(52) U.S. Cl. 700/101

(57) ABSTRACT

The present invention optimizes shop floor operations by generating production schedules that respect the complex manufacturing rules of specified production operations. The invention utilizes attribute-sensitive changeover models that consider both the duration and cost of each changeover. Since the invention considers more than just the item, changeover models can be based at the item level and the item attribute level. The invention includes realistic models that simulate operations for a variety of process and discrete manufacturing work centers and departments. These models support reusable and auxiliary resources, resource groups, user-defined units of measure, detailed bills of material (BOMs), production rate models, and production method models. The sequencing invention can be integrated with other planning optimization systems, including planning and scheduling engines, to provide further shop floor optimization to productively drive the sequencing of a complex business.

### CROSS REFERENCE TO RELATED APPLICATIONS

This application claims priority from U.S. Provisional Application No. 60/377,243, “System and Method for Scheduling and Sequencing Supply Chain Orders,” filed May 3, 2002, and U.S. Provisional Application No. 60/381,801, filed May 21, 2002, both of which are hereby incorporated by reference.

### BACKGROUND OF THE INVENTION

1. Field of the Invention

The present invention relates to system and method for scheduling customer orders. More specifically, the present invention relates to a method and system for fulfillment of customer orders in a supply chain by scheduling and sequencing multiple customer orders, scheduling and sequencing for use the various resources located in remote locations needed to fulfill such orders, and scheduling the used resources for replenishment at appropriate times so that the resources meet the needs of the orders.

2. Discussion of the Related Art

The complexity of today's supply chains makes it often very difficult to schedule and fulfill customer orders. A supply chain partner, for example, a manufacturer, is called upon daily to fulfill numerous customer orders. These customer orders may be from other supply chain partners or retail customers. Each order is typically unique in the sense that it may seek differing goods and services at different time periods. These orders may be unique not just in terms of the goods and services they seek but may be unique in the resources that may be needed to fulfill these orders. Resources may include, for example, manufacturing equipment, warehouse supplies, storage tanks, manpower, and the like. These resources may be located in a common location or may be located in remote sites. When orders are being fulfilled, it is simply not enough to make sure that the resources needed for fulfilling the orders are available at the appropriate time, but one must also make sure that the resources are adequately stocked in the case where the resource is storage equipment such as a storage tank. To properly schedule storage resources, it is not enough simply to track the actual storage amount in the resource, but one must also have a mechanism for replenishing the resource whenever the quantity remaining falls to a particular level.

As supply chains become more and more complex, it becomes increasingly difficult to schedule and sequence the multitude of resources needed to properly fulfill customer orders. Customers require not only faster delivery of goods and services, but also highly customized products that meet their unique specifications. Manufacturers face ever demanding pressures to consider the customer-specific product attributes in developing optimized schedules. This may be especially true when there is a need to prescribe to particular business goals such as Just-In-Time concepts. The challenge for manufacturers is to efficiently schedule a plant's operations while meeting customer delivery dates.

These changing conditions are driving the need for manufacturing organizations to become more productive with less investment. Common strategies to accomplish this include working from lower inventory levels and increasing the quantity of material processed in a given period. Also, many companies look to cut manufacturing costs by minimizing set and changeover times. However, with all the possible changeover combinations, it is difficult to generate a schedule—let alone a cost-effective schedule—when the product attribute complexity is significant. Conventional methods typically fail to utilize attribute-sensitive changeover models that consider both the duration and cost of each changeover. The system must be able to consider more than just the item so that changeover models can be based at the item level and the item attribute level.

Effective manufacturing operations for complex production environments must also have the ability to optimize the sequence of production orders around the unique characteristics of key constraining elements of a particular plant. They require a system that is able to improve plant throughput with existing equipment and resources. Furthermore, these complex environments require a system that can enable quick, informed decisions when a production line goes down or when unexpected events occur on the shop floor. Conventional methods that address generic manufacturing challenges do not provide the level of intelligence required to stay competitive in the most complex production environments.

In addition to the above needs, complex production environments can be improved with a system that considers manufacturing cycle time reduction to minimize work in progress (WIP) inventories and increase throughput. Such a system would preferably include realistic models that simulate operations for a variety of process and discrete manufacturing work centers and departments with these specific characteristics. These models could support reusable and auxiliary resources, resource groups, user-defined units of measure, detailed bills of material (BOMs), production rate models, and production method models.

For the reasons described above, it would highly desirable to have a system and method that allows supply chain partners to be able to schedule and sequence supply chain resources when fulfilling multiple orders in a timely manner. Such a system and method would preferably be highly robust allowing it to be applied to even complex situations relating to complex supply chain networks.

Furthermore, there is a need for a system that optimizes manufacturing operations by generating production schedules that respect the complex manufacturing rules of specified production operations. In both single and linked multi-stage production environments, this system should consider manufacturing resources and associated product attributes and their interdependencies at each stage in the process. Such a system requires an advanced algorithm to produce a globally optimal solution for the manufacturing problem based on user-defined scheduling objectives. The system should further be able to be configured to reflect the manufacturing strategies at each location of use. In addition, the system should provide fast solution times, generating schedules in minutes rather than hours, so that managers/schedulers can quickly generate scenarios to evaluate the impact of events and new manufacturing strategies on every aspect of manufacturing operations.

### SUMMARY OF THE INVENTION

Accordingly, the present invention relates to a system and method for scheduling and sequencing supply chain resources. According to one embodiment of the present invention, the scheduling and sequencing of supply chain resources may be accomplished using a two-tier system. The first-tier addresses the issue of scheduling customer orders to specific resource[s] and/or sites. The second-tier addresses the issue of actually scheduling specific resources to specific assignments in a specific sequence.

The present invention optimizes shop floor operations by generating production schedules that respect the complex manufacturing rules of specified production operations. In both single and linked multi-stage production environments, systems according to the present invention consider manufacturing resources and associated product attributes and their interdependencies at each stage in the process. The invention includes an advanced algorithm that produces a globally optimal solution for a manufacturing problem based on user-defined scheduling objectives. These user-defined objectives, such as on-time delivery and resource utilization, allow the invention to be configured to reflect the manufacturing strategies at each location of use. In addition, the solve times are fast, generating schedules in minutes rather than hours. Schedulers can quickly generate scenarios to evaluate the impact of events and new manufacturing strategies on every aspect of manufacturing operations.

The invention utilizes attribute-sensitive changeover models that consider both the duration and cost of each changeover. Since the invention considers more than just the item, changeover models can be based at the item level and the item attribute level.

In addition to minimizing set up and changeover times, the invention considers manufacturing cycle time reduction to minimize work in progress (WIP) inventories and increase throughput. The invention includes realistic models that simulate operations for a variety of process and discrete manufacturing work centers and departments. These models support reusable and auxiliary resources, resource groups, user-defined units of measure, detailed bills of material (BOMs), production rate models, and production method models. The sequencing invention can be integrated with other planning optimization systems, including planning and scheduling engines, to provide further shop floor optimization to productively drive the sequencing of a complex business.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

FIG. 1A is block diagram of an exemplary environment where a system according to one embodiment of the present invention may operate.

FIG. 1B is a flow diagram of a process for planning the utilization of resources in order to meet demand according to one embodiment of the present invention;

FIG. 2 is a block diagram of the attribute inputs that can be included in a system model according to the present invention;

FIG. 3 depicts a timeline for a typical replenishment schedule for an exemplary resource;

FIG. 4A depicts a timeline for lead time of an order using just-in-time replenishment;

FIG. 4B depicts a timeline of an exemplary lot-for-lot replenishment that has been implemented;

FIG. 4C depicts a timeline showing how an exemplary absolute time based replenishment may be implemented on a resource for material X;

FIG. 4D depicts a timeline showing how relative time based replenishment may be implemented on a resource for material X;

FIG. 4E depicts a timeline showing quantity based replenishment being implemented for a resource for material X;

FIG. 4F depicts a timeline showing how a mixed model replenishment may be implemented for an exemplary resource for material X;

FIG. 5A depicts a timeline of a period maximum replenishment being implemented on an exemplary resource for material X;

FIG. 5B depicts a timeline showing how a reorder point may be used to restore the quantity level of a resource.

FIG. 6A provides a graphical representation of a gradual type SKU usage;

FIG. 6B provides a graphical representation of an instantaneous type SKU consumption;

FIG. 6C provides a graphical representation of an instantaneous type SKU generation;

FIG. 6D provides a graphical representation of start/end synchronized SKU usage;

FIG. 7A is a timeline illustrating the function of an initial assignment;

FIG. 7B is a timeline illustrating how an initial assignment is prorated based on the amount of time after an OHPost;

FIG. 8A is a flow diagram of the process for netting orders;

FIG. 8B is a flow diagram of the process for netting raw materials;

FIG. 8C is a flow diagram of the process for netting WIPs;

FIGS. 9A-9D are exemplary timelines depicting inventory levels and need quantity over a period of time;

FIG. 10A is a diagram showing tank fragmentation;

FIG. 10B is a flow diagram of best tank heuristics for replenishment;

FIG. 11A is a flow diagram for creating replenishments;

FIGS. 11B and 11C are a flow diagrams of the decision sequence in determining whether it is feasible to replenish;

FIGS. 12A-12C are figures depicting the impact of shelf life on sequencing; and

FIG. 13 is a flow diagram for determining whether or not to delay material.

FIG. 14 depicts a computer-based sequencing system according to an embodiment of the present invention.

### DETAILED DESCRIPTION OF THE PREFERRED EMBODIMENTS

Reference will now be made in detail to the preferred embodiment of the present invention, examples of which are illustrated in the accompanying drawings.

The invention disclosed herein incorporates by reference the subject matter of co-pending and commonly assigned U.S. Non-provisional Patent Applications “System and Method for Order Group Planning with Attribute Based Planning,” Crampton, et al., application Ser. No. 10/287,788; “System and Method for Replenishment by Manufacture with Attribute Based Planning,” Crampton et al., application Ser. No. 10/287,775; “System and Method for Replenishment by Purchase with Attribute Based Planning,” Crampton et al., application Ser. No. 10/287,805; and “System and Method for Order Planning with Attribute Based Planning,” Crampton et al., application Ser. No. 10/287,773; all filed on Nov. 5, 2002.

The present invention provides a system and method for scheduling and sequencing supply chain resources. The system, called a sequencing system, can model stock keeping units (“SKUs”) as well as attributes (i.e., fundamental characteristics). Each SKU associates an Item and a Location. The SKU has predefined attributes and user defined attributes. The SKU may be raw material, work-in-process (“WIP”), finished good, or both WIP and finished good. The SKU may be hard or soft constrained and if raw material will have a replenishment model that tells whether the material can be replenished, and if so, how.

The sequencing system and the process implemented by the system generate an output that defines a plan for using the resources of a supply chain. The output may be in text, raw data, graphical or any other form useful for planning purposes. The sequencing system may interface with various other business planning, scheduling, purchasing, collaboration, and promising type systems and applications as are known in the art, including NetWORKS Strategy™, NetWORKS Attribute Based Planning™, and NetWORKS Collaborate™, all commercially available from Manugistics, Inc. The various functionalities associated with the sequencing system may be best understood by the following description together with the accompanying drawings describing the various concepts used to implement the novel aspects of the present invention.

The sequencing system, according to one embodiment of the present invention, is a robust planning system that can operate in a highly complex and highly dynamic environment. The system may be implemented using a combination of both hardware and software, which may include a database. Alternatively, the system may interface with one or more databases located on a single or multiple computer devices such as personal computers, workstations, servers, and the like.

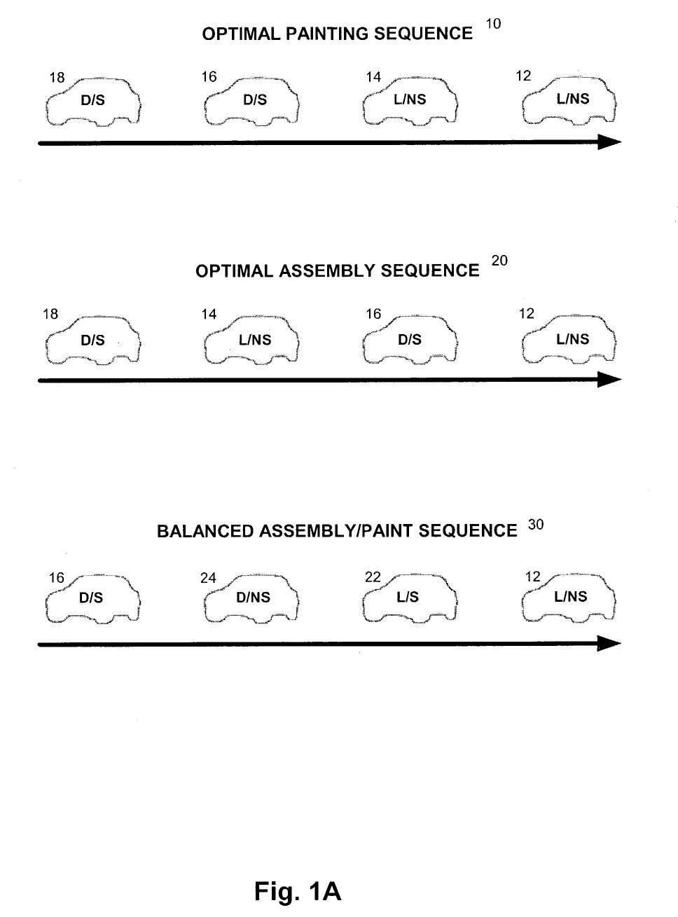

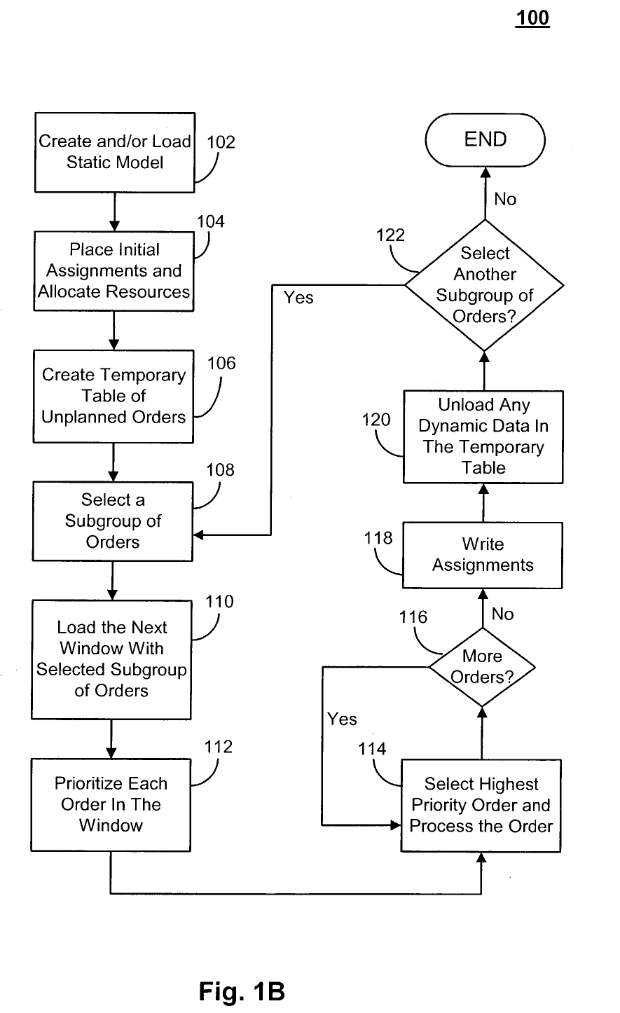

As an example, an environment that may benefit from the sequencing system would be a large assembly plant. In a simplified production model shown in FIG. 1A, consider the assembly line of an automobile plant where cars are manufactured in two colors (dark, D, or light, L) and with the option of a sunroof (yes sunroof, S, or no sunroof, NS). The plant has orders for four cars with the following specifications: order 12 is for a light car with no sunroof, order 14 is for a light car with no sunroof; order 16 is for a dark car with a sunroof, and order 18 is for a dark car with a sunroof. In FIG. 1A, production flow 10 depicts the optimal production sequence for a car painting assembly, which would be to complete all the cars of one color before changing over to the other color; such as car 12, followed by car 16, car 14, and car 18 in order. Production flow 20 depicts an optimal production sequence for assembling the cars, which would be to alternate assembly of cars with a sunroof and cars without a sunroof in order to balance the timing of the assembly line; such as car 12, followed by car 14, car 16, and car 18 in that order.

Thus, in this example, the optimal assembly sequence in the production line results in an inferior painting sequence. Conversely, the optimal painting sequence in the production line would require an inferior assembly sequence. Thus, in this example, the painting process and assembly process are defined by competing metrics that must be balanced in the production cycle. To accommodate these competing metrics, a buffer between the two stages could be used to achieve optimal production at each of stage 10 and 20. A buffer is an area between two stages where things can be rearranged and stored. However, use of a buffer may result in a loss of overall production efficiency.

Still referring to FIG. 1A, production flow 30 depicts a balanced sequence for both painting and assembly, so that like colors are panted together and sunroof installations are alternated. In the sequence, two cars for other orders (car 22 and car 24) have been inserted into the workflow between car 12 and car 16 to make optimal use of the assembly line resources. Cars 14 and 18 must be completed either earlier or later in the assembly line. By modeling the constraints of the painting process (such as changeover time and paint tank supplies), the constraints of the assembly process (such as storage of parts, tooling changes, and labor time), the constraints of the buffer (such as storage capacity), and the overall demand for production resources, the most efficient overall sequence for production of the four cars orders in can be identified.

As more stages and constraints are introduced into the production model, the model complexity increases exponentially. Constraints may exist that are specific to a resource, to a group of resources, to a location or a group of resources. Further, the car manufacturer may implement certain rules that place more limitations on the resources and locations. Each resource may be associated with one or more materials. Material is any component material or even finished goods that may be needed by a resource to produce a particular type of finished good. One way to view the resources is to view them as a well that may be replenished by, for example, manufacture, purchase or substitution. Other materials may also support materials. That is, materials that go into resources may be made from other materials. The car manufacturer has several customers who submit orders to the manufacturer. These orders can be parsed by the system and a plan generated for the optimal use of the resources for fulfilling multiple orders. Each order contains relevant information that may be used to create certain parameters when scheduling orders. These include requested delivery date and location, identification of the requested goods, quantity of requested goods, customer identification, transportation mode, and the like. The finished goods requested in the order may be viewed as a “finished good stock keeping unit” (“FG SKU”). Typically, there will be multiple configurations and component materials that meet the requirements of each FG SKU ordered.

Ideally, a robust manufacturing resource planning systems will also be able to accommodate a number of other important factors when planning the utilization of network resources. For instance, ordering and/or manufacturing material at the right time is required if the finished goods are to be delivered on or near the desirable date. If materials are not ordered at the proper time, then there will be insufficient material to fulfill orders. Ordering of materials prior to the time when the parts are needed is one of the keys to having efficient and timely manufacturing capabilities.

Planning and scheduling is a continuous process. Thus, any effective planning system must be able to accommodate already scheduled assignments or orders that have been scheduled before attempting to fulfill new orders using the manufacturing resources available.

Preferably a reliable planning system will be able to accommodate idiosyncrasies, business rules and goals of many types of manufacturers including those having large and complex manufacturing networks. For example, a manufacturer may follow Just-in-Time concepts and would therefore want the ordered goods to be made just before the requested delivery date. On the other hand, the manufacturer may prefer to deliver goods on the earliest date that is acceptable to the customer. These goals are specific to each manufacturer and may be specific to certain types of orders (through model, customer, priority, etc) and may help a manufacturer to realize its long-term goals. Thus, a system that recognizes and accommodates the particular needs of a manufacturer may be highly desirable.

A business, such as large manufacturer, typically receives a number of orders from multiple customers and/or may make forecasts for customers that have yet to give their orders. A customer may be a third party, a division within the same business, a supply chain partner or any other buyer. Each order received by the business may be defined by its attributes such as customer name, order identification, requested SKU, need date, quantity and the like. Typically an SKU will be defined by at least two attributes, name of good[s] and location. An SKU may have values for user-defined attributes. SKUs may also be grouped into finished good (“FG”) SKUs, work in process (“WIP”) SKUs, or raw material SKUs. The items for raw material and WIP SKUs may be subordinate in the BOM. A subordinate item is a component part or material that is needed to create another item. Note that the values for user defined attributes for orders may override the values for user-defined attributes for SKUs.

To support the various features provided by the present invention, a number of database tables may be created. The tables are made up of rows and columns. The value of the rows and columns will depend upon the type of tables they are. Tables may be created for a number of entities including BOM, SKU groups, inventory table, items (all finished goods and subordinate materials should be listed), Locations, Resource, Resource groups, and the like.

FIG. 1B illustrates a process 100 for creating a plan or modifying an existing plan for utilizing network resources in order to fulfill demand according to one embodiment of the present invention. A discussion that briefly introduces the various steps defined in flow processes 100 is provided below, followed by a more detailed discussion of specific steps and concepts introduced in the process.

In brief, the process 100 begins at step 102 when a static model of the operating environment is loaded and/or created. The static model may be modeled by defining or loading certain input data, for example, horizon information, SKU constraints, scheduled receipts, bills of material, and initial assignments. These inputs will be discussed in greater detail below.

At step 104, initial assignments are placed and materials are allocated accordingly. Before the sequencing system makes plans for fulfilling any not-yet-planned orders, it may plan for orders with pre-defined assignments during the initialization step 104. Initial assignments are used to “freeze” orders. That is, they may be used to reserve a location/resource[s] for fulfilling a particular order[s] before the planning process is run. Before planning order, orders with pre-determined assignments will preferably be scheduled. This may be accomplished by invoking an initial assignment placement routine. In some situations, a pre-assignment table may be created to define pre-determined assignments. Such a table may contain information such as: the ID of the order to be assigned, the resource to which the order is assigned, and the quantity of the order to be associated with this assignment. The BOM configuration information for initial assignments may be stored in a BOM table. Upon invocation, the initial assignments may be processed in the pre-assignment table.

At step 106, the system creates a temporary table of unplanned order or orders. Next process 100 shifts to planning the utilization of network resources in order to fulfill demand as defined by, for example, orders that have not yet been planned (i.e., unplanned orders). In brief, process 100 requires at step 108 a selection of a subgroup of orders, which may be the entire group of unplanned orders. At step 110, the next window is loaded with the selected subgroup of order or orders and its associated items. The items that may be associated with the order or orders include for example, configurations, BOMs, subordinate SKUs, Finished Good SKUs, and the like.

At step 112, each order is prioritized in the window. Those orders with higher priority will generally be scheduled before those that have lower priority. The orders are prioritized and sorted. In general, when multiple orders are present, the orders are processed one after the other. Orders that are processed first generally get the first access to materials and capacity. Since it is preferable that certain orders be process before others, preferably the system uses a mechanism for prioritizing orders. This mechanism for prioritizing orders is called sorting. The order sorting mechanism allows for modeling order groups and sorting criteria in such a way that the highest priority orders get processed first. Orders may be sorted within each group by a user-defined criterion. The criteria may be different for each group. For example, orders within one group may be sorted by need dates while orders for another group may be by a pre-defined priority number. If two orders have the same priority, they may be processed in the sequence returned by the database.

At step 114, the highest prioritized order not yet planned is selected and the order planned. If there are any more unplanned orders in the window then the next highest prioritized order is scheduled as indicated by step 116. Otherwise, at step 118, assignments are written so that appropriate resources and/or materials that are needed to fulfill the orders may be reserved. Once the assignments have been written, the dynamic data in the temporary table may be unloaded at step 120. At step 122, a determination is made as to whether other slices of orders need to be processed and if so, the process returns to step 108 to cycle through process 100 from that point.

A more detailed description of some specific steps and concepts introduced above for process 100 follows.

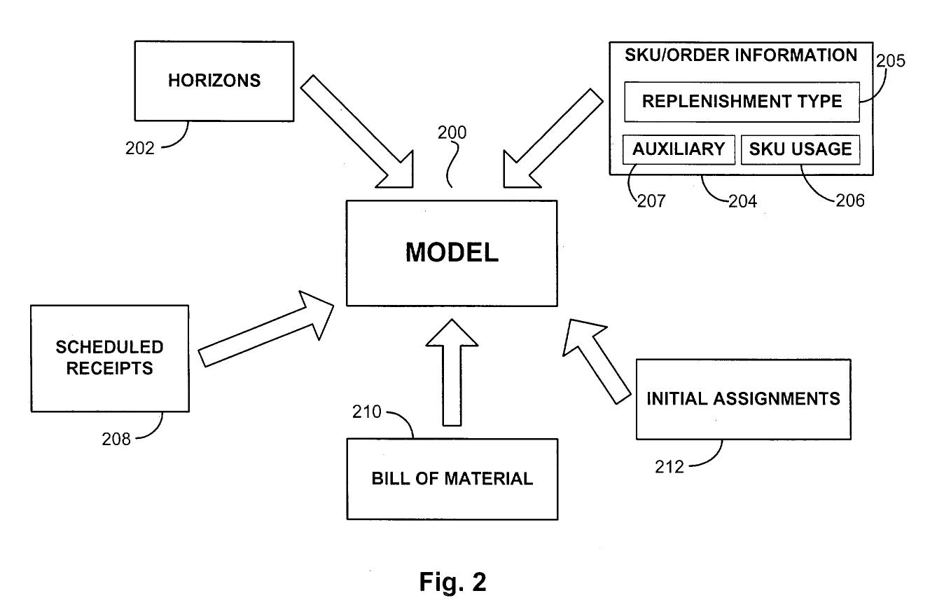

Sequencing process 100 typically begins when the planning model is defined at step 102. As show in FIG. 2, at least five types of data may be inputted and processed by model 200. These include horizons 202, stock keeping units (“SKU”) and order information 204, scheduled receipts 208, bill of material 210, and initial assignments 212. Each of these inputs will be discussed below in greater detail. Those skilled in the art will recognize that a number of other generally static and dynamic entities may also be defined during the modeling stage of the planning process.

Horizons: The first basic category of system inputs is horizons. Horizons relate to planning periods. Two or more types of horizon data may be used to help define business rules: scheduling horizon and material horizon. In scheduling, a horizon start time and a horizon end time is preferably defined. When a horizon start time is defined, no new assignment may start before the horizon start time. When a horizon end time is defined, delays may not be enforced after the end time and in the final solution, no route may start after the horizon end time.

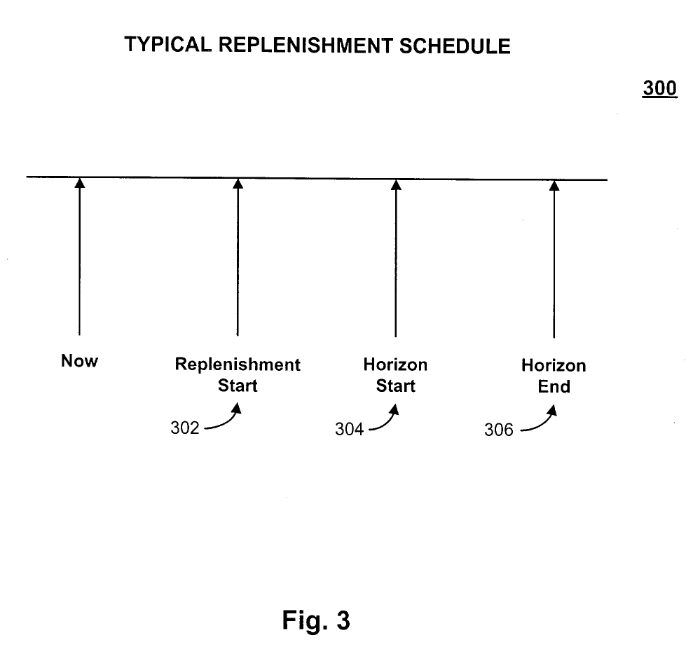

Material horizon relates to the replenishment start time or date. Typically all replenishment lead times will be counted from the replenishment start time (which is generally no later than the horizon start time). The relationship between replenishment start time 302, horizon start time 304 and horizon end time 306 may be better understood by referring to FIG. 3, which depicts a time line 300 for a typical replenishment schedule for an exemplary resource.

When scheduling, the user typically generates a schedule days, if not weeks, before the schedule is executed. For the purpose of discussion, assume that the user generates a schedule on Monday and Tuesday for the following Monday. In this case the horizon start will be set to the following Monday thereby guaranteeing that no assignment will start before Monday. Note that each resource may have a flag that can restrict changeovers to start after the horizon start. Additionally, in this example, the replenishment start can be set to Wednesday. In this way, replenishment lead times can start from the replenishment start 302, which may be before the horizon start 304 thereby allowing replenishments early in the schedule. As the user schedules Monday and Tuesday, one ensures that the lead times are computed with respect to the actual lead time start.

In practice, most systems do not distinguish between the horizon and replenishment start. When on-hand amounts do not cover the initial schedule need, this causes gaps in the beginning of the schedule. Typically, the user adjusts the scheduled receipts and reruns the scheduling algorithm thereby getting rid of the gaps. By separating the replenishment start, this task is simplified. To match the standard behavior, one only needs to set the replenishment and horizon starts to the same date. When schedules are rolled, one typically needs only modify the horizon start and replenishment start before scheduling the new demand set.

SKU and Order Information: As shown in FIG. 2, a second basic category of system inputs is SKU and order information 204. Information relating to SKUs and/or orders may be stored and used by the system to define priorities. Orders may be defined by one or more attributes. These attributes may include, for example, SKU (e.g., item and location), need date, quantity, start date, supply flag, and user defined attributes (herein “UDAs”). UDAs are any attributes that a user wishes to use to define an order. One or more types of attributes may also define SKUs. These attributes may include, for example: constraint (hard, soft, none) and material type (finished good, raw material), user defined attributes; on-hand and on-hand post; lead time and lead time units, period, period units, maximum period quantity, period absolute/relative flag, minimum, incremental, and maximum reorder quantity, SKU reorder point and tank minimum level, stage synchronized (can be specified by stage), schedule coverage and scheduled coverage units, usage, effective start, and work-in-progress (herein “WIP”) cycle time.

Although each SKU may be defined by a single attribute, typically each SKU will be defined by at least two attributes, item and location. Each SKU may also be classified by type. For example, they may be classified as raw material or finished goods. If they are classified as raw material, then the SKUs may be used, for example, for netting and may only be purchased rather than be created.

“On-hand” and “on-hand post” are attributes that define the amount present at the given time for general inventory. If the SKU is to be held in a tank, a scheduled receipt should be used rather than the on-hand. Scheduled receipt is used to denote the material arrival at the instantaneous start of the scheduling horizon, or at a later time in the horizon is not produced by an upstream resource. Example of later material arrival would be a purchased material or one transferred from another plant/storage facility.

The effective date attribute will prevent scheduled receipt from being created before the effective date. Further, no usage may occur before the effective date.

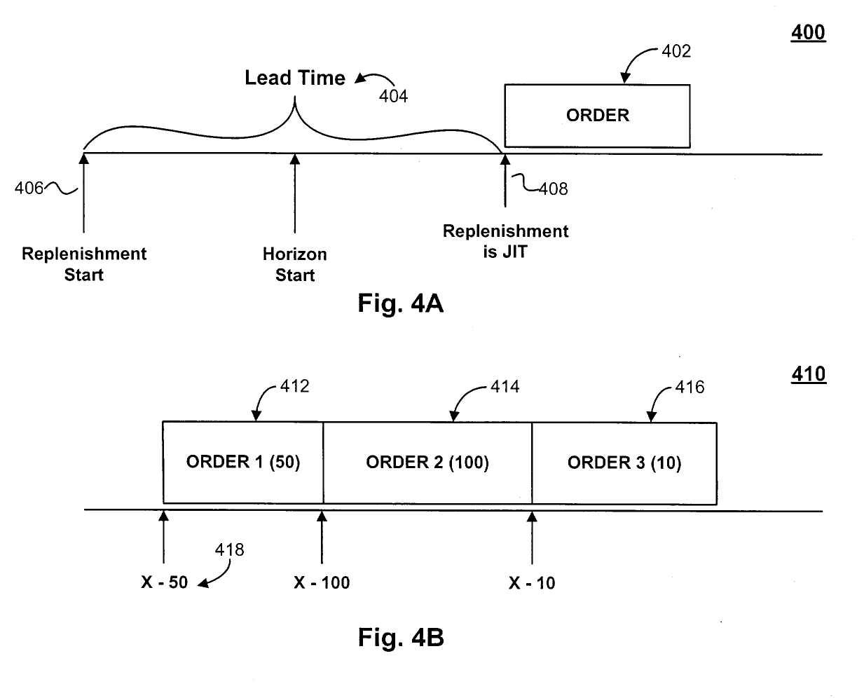

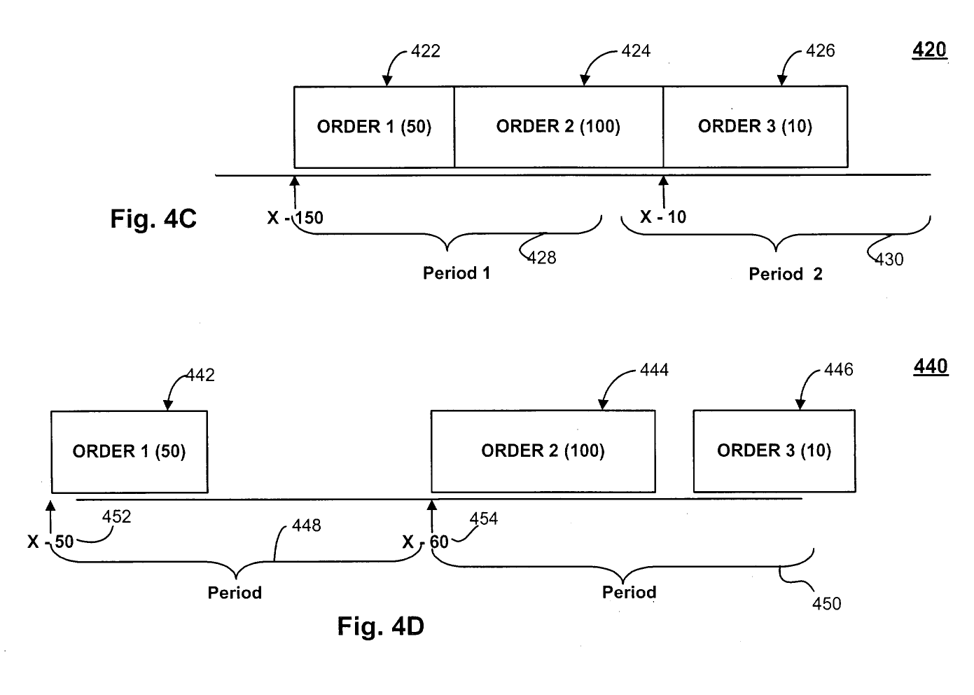

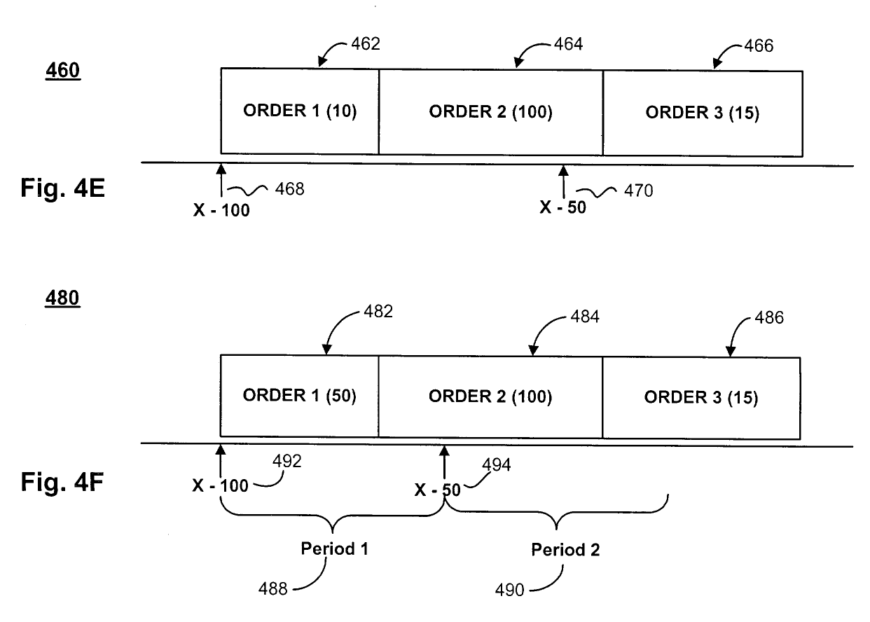

The lead-time attribute may be used for both soft and hard constrained SKUs. Lead-time is the earliest time that the replenishment start time may be set at. Lead-times may be finite (for replenishable SKUs) or infinite (not replenishable). Generally though, as shown in FIG. 4A, purchases are synchronized Just-in-time (JIT) with the use of the material (i.e., the SKU). FIG. 4A is time line showing any ideal implementation of JIT replenishment. A lead time 404 for resources to support an order 402 is shown. The replenishment start 406 for the resource is timed such that the lead time 404 for the resource ends at a point 408 immediately prior to the start of processing the order.

Various other types of types of information can be modeled within the SKU and Order Information inputs 204, including replenishment type 205, SKU usage 206, and auxiliary usage 207. Replenishment types 205 include lot-for-lot, absolute time based, relative time based, quantity based, and mixed model replenishments. Period maximums and reorder points may further define each replenishment type. The various replenishment type inputs are discussed below.

Lot-For-Lot (LFL) replenishment. Several approaches may be used to replenish resources. For example, one approach is the Lot-For-Lot replenishment. Referring to FIG. 4B, time line 420 depicts how an exemplary Lot-For-Lot replenishment rule that has been implemented. In Lot-For-Lot replenishment, a scheduled receipt is generated for each order and material that needs to be purchase. Under Lot-For-Lot, it is preferable that scheduled receipts generated from two separate orders are not combined. In this example, three orders, order1 412, order2 414, and order3 416 have been scheduled for a resource for material X. Each order1 412, order2 414, and order3 416 has a different a time duration and quantity (as shown between the brackets) requested. When order1 412 is initially scheduled, 50 units of material X is drawn. As a result, a scheduling receipt for 50 units of X will be generated at 418. Similarly, when the order2 414 and order3 416 are scheduled, corresponding scheduling receipts for 100 and 10 units of X will be generated at the start of order2 and order3.

Absolute Time Based Replenishment. In absolute time based (herein “ATB”) replenishment, an absolute time period with respect to a horizon start is defined. In ATB replenishment, scheduled receipts are aggregated within defined time period[s]. Preferably, the scheduled receipts are treated like a forward coverage duration. That is, they are moved forward in time to the starting time of the order. Thus, the time on a receipt will generally be at the beginning of a period. It is preferable that the reorder information not be set. To illustrate, refer now to FIG. 4C, which is a time line 420 showing how an exemplary ABT replenishment may be implemented on a resource for material X. Note that the order1 422, order2 424, and order3 426 mirror those in FIG. 4B to better highlight the difference between the LFL replenishment and ABT replenishment approaches. In this example, there are two time periods 428 and 430 and the three orders 422, 424, and 426 that have been scheduled during the two time periods. The quantity requested for the order1 422 and order2 424 have been aggregated (i.e., summing 50 and 100 for a total of 150) and the corresponding scheduled receipt is at the beginning of period 1 428. Order3 426 is covered in the next period of coverage duration, period 2 430. The scheduled receipt for order3 426 arrives at the start of the period to make sure of coverage for the order.

Relative Time Based Replenishment. Refer now to FIG. 4D, which is a time line showing how RTB replenishment may be implemented on a resource for material X whereby each order needs a one-to-one draw. In Relative Time Based (“RTB”) Replenishment, a relative time period is initially defined. The scheduled receipts, within a time period, are aggregated according to RTB replenishment. They are treated like a forward coverage duration—moving from left to right. Generally the time on a receipt will be the time of the earliest order in the group. The reorder information is typically not set. In this time line there are three separate orders, order1 442, order2 444, and order3 446 and two time periods 448 and 450. Each order has unit quantities defined (as indicated by the number within the brackets). As shown, the scheduled receipt 452 and 454 for each group of orders for each of the time periods 448 and 450 is set at the beginning of their respective time periods.

Quantity Based Replenishment. In Quantity Based (“QB”) replenishment, the minimum, increment, and maximum reorder quantities are each defined. Refer to FIG. 4E, which is a time line showing QB replenishment being implemented for a resource for material X. QB replenishment requires that purchases will always “cover” the need for each order. The time on a scheduled receipt will typically be the time of the earliest order in the group. Generally under QB replenishment, period information is not set. Again, in this time line 460, three orders, order1 462, order2 464, and order3 466 are depicted. Note that in this replenishment, there are no time periods. In this example, assume that each order needs one material X with a one-to-one draw with a minimum of 50, increments of 10 and maximum of 100. Thus, receipts 468 and 470 are scheduled whenever a need arises regardless of the timing of the order[s] or some arbitrary time periods. A need will arise whenever the quantity contained in the resource is less than the desired amount for the resource.

Mixed Models Replenishment. In Mixed Models (“MM”) Replenishment, receipts may be scheduled by using time based and quantity based approaches at the same time. To illustrate how MM replenishment may be implemented, we now refer to FIG. 4F, which is a time line 480 showing how a MM replenishment may be implemented for an exemplary resource for material X. When MM replenishment is implemented, absolute time periods must be specified. Further, minimum/increment/maximum reorder quantity is preferably specified. In MM replenishment, purchases will be aggregated by quantity in each period. The purchases will also preferably be at the beginning of the period. In this example, there are three orders order1 482, order2 484, and order3 486, each immediately succeeding or preceding another, and two defined time periods 488 and 490. Although not indicated in the FIG. 4F, in this example, suppose we assume that the minimum, increment, and maximum units have been defined as 50, 10, 100, respectively. The two time periods 488 and 490 are absolute time periods. Note that the first receipt 492 is located at the beginning of order 1 while the second receipt 494 is located at the beginning of period 2. This is because the maximum reorder quantity is 100 and the minimum quantity is 50.

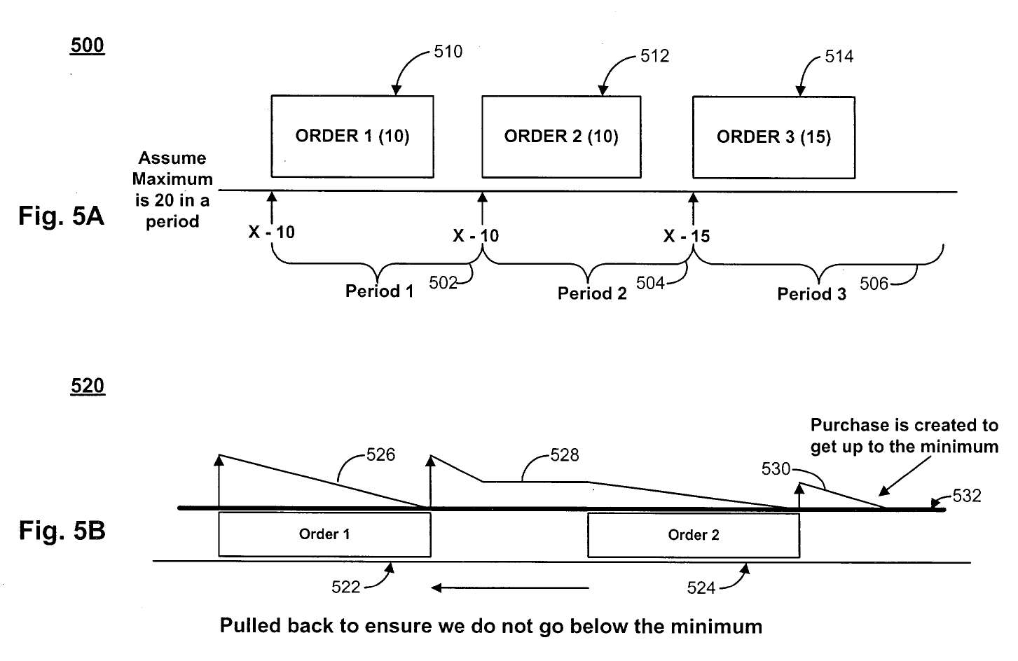

Period Maximum Replenishment. A period maximum (“PM”) replenishment can be added to any model and does not vary through time. Refer to FIG. 5A, which is a time line 500 that depicts a PM replenishment being implemented on an exemplary resource for material X. No period will have replenishments more than the specified amount. Periods are absolute and start from the horizon start and do not have to be synchronized with the order periods. An order period is the time in which the order is to be made. An order will not be split so that the period maximum rule is not violated. Instead, if an order results in an aggregated sum for the period being greater than the allowed period maximum, than the entire order may be delayed. In the example of FIG. 5A, we assume that the maximum reorder quantity for a period is 20. There are three order periods order1 502, order2 504, and order3 506 and three time periods 502, 504, and 506. Time line 500 illustrates how the orders for each period fall within the allowed period maximum defined in the model.

Reorder Point. A reorder point may be defined for replenishment of specific resources. A reorder point is the quantity level of a resource at which point an order[s] is generated so that the resource may be restored to some desirable level. Referring to FIG. 5B, a timeline 520 shows how a reorder point may be used to restore the quantity level of a resource. When a SKU falls below a specified reorder point, the system generates order[s] so that the quantity levels of the relevant resource is restored to a desirable level such as full capacity. Generally, when a SKU falls below the reorder point for a given resource, a portion of the replenishment is used to cover the shortfall. If there is not replenishment then the system may create one. Shelf life is not considered. The use of a reorder point is analogous to a safety stock. A horizontal line 532 represents a predetermined minimum level, the reorder point, for a given resource required to supply two orders 522 and 524. The level of resources (526, 528 and 530) drops as each order is filled, such that completion of order 524 would reduce the level to the reorder point. Because there is not a scheduled replenishment, the system creates one to bring the supply level above the predetermined minimum.

Tank minimum level. For dedicated tanks only, minimum levels for tank resources can be maintained. The system establishes a reorder point the same as for a SKU, but using the minimum level in a tank. However, the SKU replenishment model minimums, increments, and maximums are not used. In using the minimum tank level, no replenishment will exceed the tank capacity. If needed, multiple replenishments will be created and distributed in time as needed.

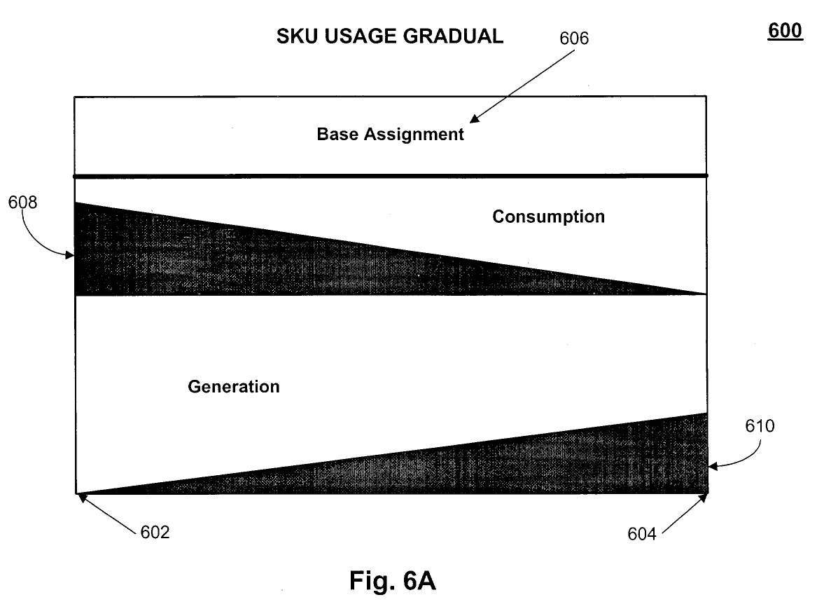

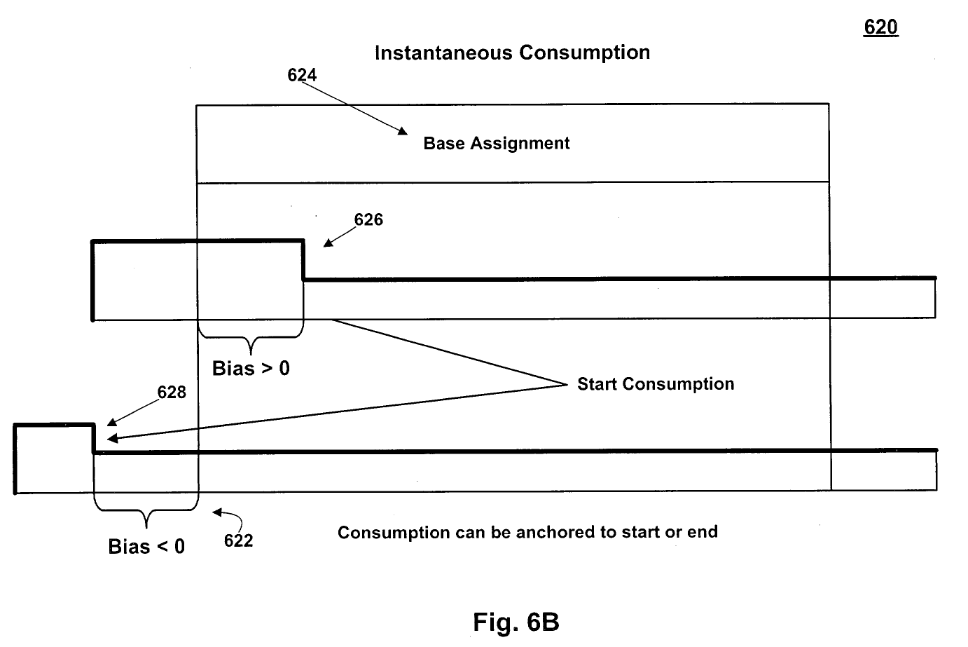

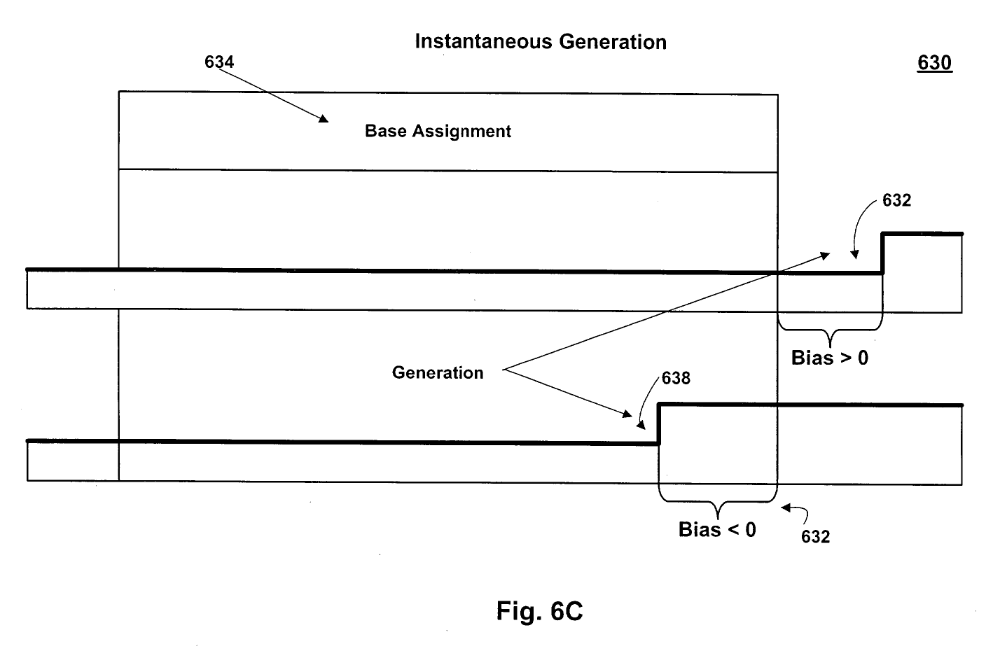

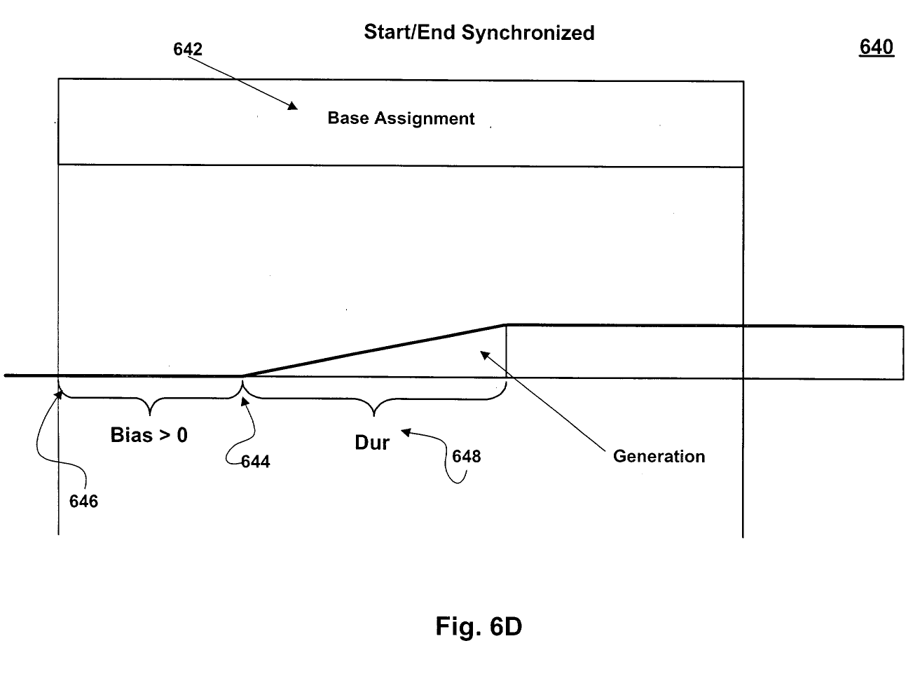

Returning to FIG. 2, SKU usage 206 may be modeled to define how a SKU is used for the duration of the parent assignment, including both consumption and generation. Three types of usage can be selected: gradual; instantaneous; and start/end synchronized. One of the three types is specified as an attribute of the SKU for consumption and generation. However, the usage type can be overridden by the user in a production method table for route specific usage. FIG. 6A provides a graphical representation of a gradual type SKU usage using time line 600. Assuming the start of a base assignment 606 at a starting point 602, resources are gradually consumed to fill an order along a line 608. At the same time, resources are being generated at a similar rate to along a line 610.

FIG. 6B provides a graphical representation of an instantaneous type SKU consumption using time line 620. SKU consumption to support base assignment 624 occurs at start point 622, just after the start point at 626, or just prior to the start point at 626, depending on the bias required to support timing of the order. The consumption required to support the base assignment is assigned instantaneously at the start consumption point. Similarly, FIG. 6C provides a graphical representation of an instantaneous type SKU generation using time line 630. SKU generation to support a base assignment 634 is allocated at a point 632, just after that point at 636, or just prior to that point at 636, depending on the bias required to support timing of the replenishment. The generation required to support the base assignment is assigned instantaneously at the generation point.

FIG. 6D provides a graphical representation of start/end synchronized SKU usage using time line 640. The start/end synchronize usage model attribute can be used for consumption or generation. It can also be anchored to either the start or end of the base assignment. Bias can be less than 0 or greater than 0 as depicted in FIG. 6B and FIG. 6C. Duration must be greater than 0 and is generally predefined. In FIG. 6D, for example, generation is shown from a point 644, which is anchored to a start point 646 of the base assignment and generated over a duration 648.

Returning again to FIG. 2, auxiliary usage 207 applies the same principles for SKU usage discussed above, but applies them to auxiliary resources. The duration of the auxiliary assignment mirrors that of the primary resource assignment. The auxiliary assignment is either begun at the start or the end of the parent primary resource assignment, within a bias, or off set, between the start time of the primary resource assignment and the start of the auxiliary assignment. The duration of the auxiliary is based on the primary resource assignment (for example, when a particular primary assignment duration is 10, a corresponding auxiliary assignment duration may be 5, and so on).

Scheduled Receipts: Referring back to FIG. 2, the third basic category of system inputs is scheduled receipts 208. One way to replenish resources is by generating scheduled receipts. A scheduled receipt may be viewed as an order to replenish a resource. The scheduling receipts may have certain attributes such as: model; item and location; start and end times; start and end quantity (can be positive/negative); intermediate storage resource (ISR) name and location; and expiration date. A scheduling receipt may not be restricted in time. They can be before, during, or after horizon. Durations in tanks can be used with simultaneous fill/drain to stop drains until the fill is done.

Bill of Material: The fourth basic category of system inputs is bill of materials 210. A bill of material (“BOM”) is a structure that describes the various ways an SKU can be manufactured. Each record typically associates a parent item with a child (herein also a subordinate) item and a draw quantity that tells how many child units are required for each parent unit. Additionally, attribute restrictions may be present that tell when the record may be applied. Each parent/child relationship has the following attributes: model; item and location; subordinate item and location; effective date; draw quantity; and sequence number. If the effective start is after the horizon end, the relationship will not be used. Relationships with the same sequence number form a configuration. Thus, a configuration may be defined as a set of BOM records that completely defines a specific buildable configuration for an order for a SKU.

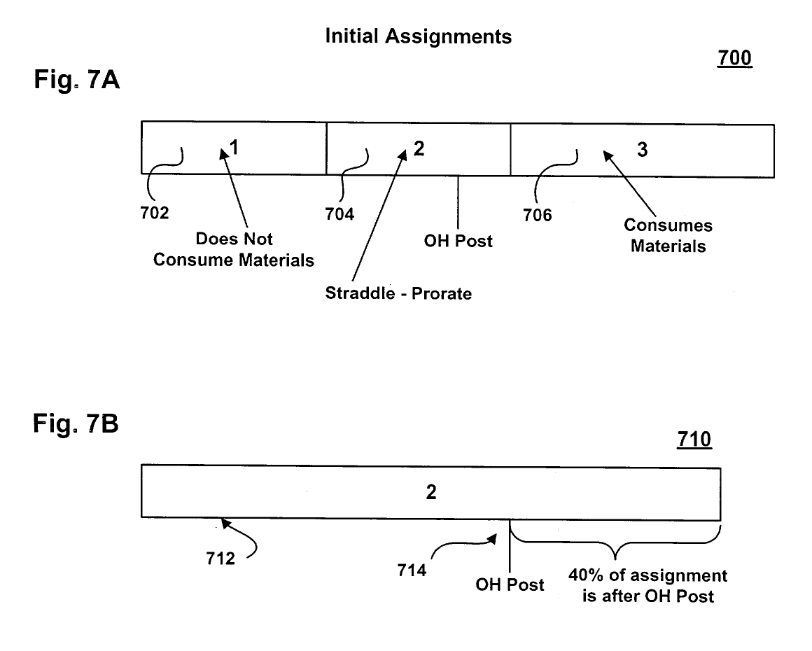

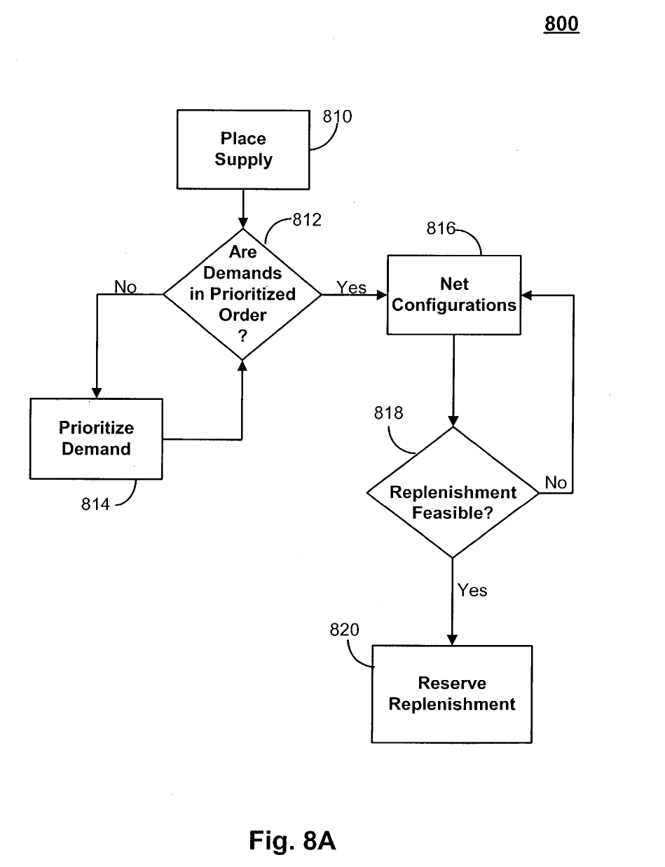

Initial Assignments: The fifth basic category of system inputs is initial assignments 212. The function of an initial assignment is illustrated in timeline a 700 of FIG. 7A. An initial assignment is one that is given to the system that represents previous commitments that should be honored whether feasible or not. An initial assignment consumes materials for the amount that overlaps the horizon. The BOM number in the initial assignment table specifies the configuration. If needed, purchases will be created to keep material feasible. Timeline 700 shows that some initial assignments can be made to not consume material, while others can operate of OHPost to either consume a prorated amount or a full amount of material available at the time. OHPost (on-hand post) is the introduction at a given point in time of new material—for example, something that was not available is now present—that can be consumed based on the existing constraints and defined characteristics.

OHPost can be utilized or not utilized, depending on the modeled characteristics of a set of orders and their production assignments. First the system must determine when the SKU usage occurs, based on the usage type described in FIGS. 6A-6D. The initial assignment is then prorated based on the amount of time after the OHPost. For example, assume in FIG. 7B a timeline 710 with an order 712 for 100 finished goods with a 2-1 draw of SKU per ordered good and 40% after the OHPost. The number of units needed after a point 714 is determined as follows: 100*2*0.4=80 units.

Once the inputs—including horizons 202, SKU and order information 204, scheduled receipts 208, BOM 210, and initial assignments 212—have been entered, the system can apply a series of algorithms to produces a globally optimal solution for the manufacturing problem based on the user-defined scheduling objectives. Referring back to step 114 of sequencing process 100 (FIG. 1B), processing the highest priority order can be divided into three basic categories: netting, optimization, and post processing. Each of these basic categories is discussed in more detail below.

Netting: Demand prioritization can be weighted according to varying business goals. The default prioritization is ascending need date and descending priority. However, a user may override the defaults to sort on any of the standard order attributes. Netting involves grouping either orders, raw materials or work-in-progress (WIP) to optimize the flow of resources in accordance with user-defined priorities. Whatever the defined prioritization, the system will seek to group orders with the same configuration. A configuration for a SKU is a set of subordinates that are required to make it. Multiple configurations are allowed and assumed to be in preference order (ascending sequence number). For a given order, if no configuration is feasible (i.e., cannot be replenished), an exception will be placed on the order and it will not be considered for optimization. The system does not try to reduce the order quantity and make less.

Netting Orders. Orders are netted for finished goods only, although netting may be at multiple levels. In cases where there is a pre-netted demand with relationships between orders, the system assumes the given relationships. A pre-netted demand means that the relationships and requirements are given to the system by the user, not calculated by the system. Thus, when a pre-netted demand exists, there may be excess supply relative to demands. Otherwise, the system creates additional supplies as needed. The demand conditioner handles schedule coverage, batch models, and ISR without simultaneous fill/drain. In cases where there is a pre-netted demand without relationships between orders, the system assigns supplies to demands on a first-come first-serve basis. If multiple subordinate orders are available, the system chooses the best covering order whose need is nearest the demand. If no order covers, the largest available order is chosen.

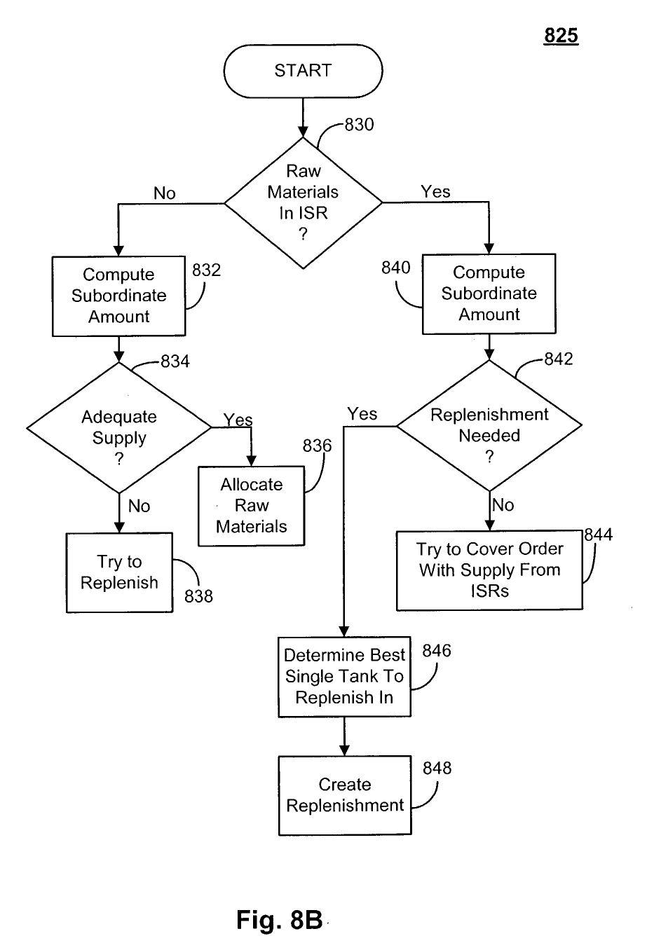

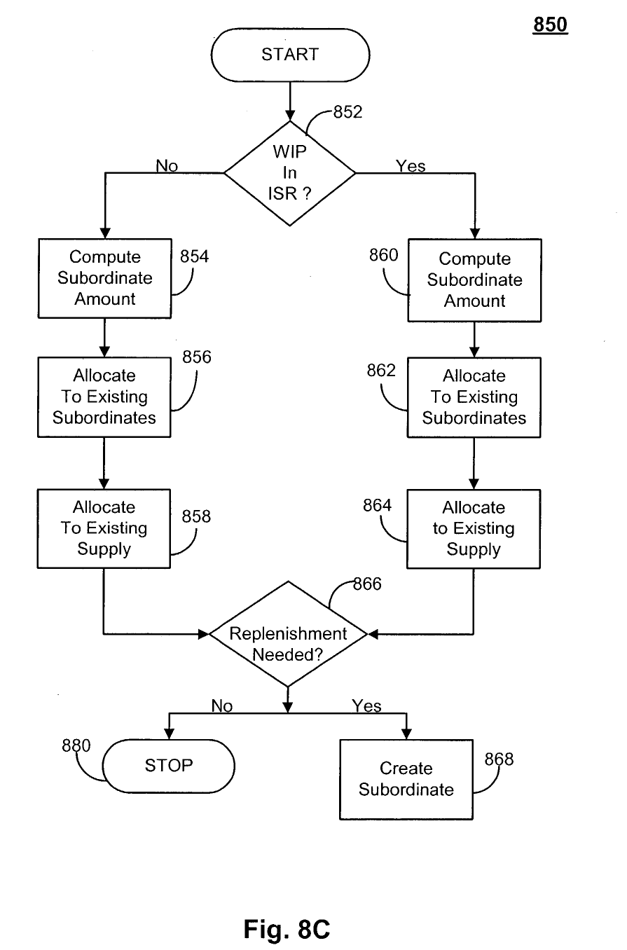

Netting of orders can be further understood by referring to FIG. 8A. In flow process 800, step 810 requires placing supply for all demands that are marked as supply. This step helps support SKUs. that can be both finished goods and subordinates. At step 812 the system checks to see if demands are already in prioritized order. If not, the demand is prioritized in step 814. In step 816, prioritized orders are netted by configurations. Then, in step 818, the system checks to see if replenishments are feasible. If yes, then a reservation is made and the process stops. If no, the process cycles back to step 816 to re-net by different configurations.

Netting raw material: Netting of raw materials to support orders is best understood by referring to FIG. 8B. In flow process 825, netting of raw materials is initially based on step 830, determining whether the necessary raw materials are available in an intermediate storage resource (“ISR”). When the raw material is not in an ISR, the system must compute, in step 832, the subordinate amount. The system must then determine in step 834 if there is enough raw material supply (either on hand or future). If there is adequate supply, then it is allocated in step 836. However, if there is not an adequate supply, tank replenishment is needed, and the system will try to replenish in step 838. If step 830 determines that raw material is in an ISR, the system must, in step 840, compute the subordinate amount. The system then proceeds to step 842 to determine if replenishment at the ISR is needed to support the order. If not, the system will then try to cover the order with supply from ISRs in step 844 using a greedy best fit method. If replenishment is needed, then the system will proceed to step 846 to find the best single tank to replenish in and then to step 848 to create replenishment in that tank.

As a result of the above netting logic for raw materials, each order has allocations to on-hand raw materials (first) and scheduled receipts (second) and new purchases (if needed). New raw material purchases will have the earliest starting time equal to the replenishment start date plus required lead-time. No subordinate orders are created.

Netting WIP: Netting of works-in-progress (WIP) to support orders is best understood by referring to FIG. 8C. FIG. 8C shows a process 850. Netting of raw materials is initially based on step 852, determining whether the necessary WIPs are available in an intermediate storage resource (“ISR”). When the WIP is not in an ISR, the system must compute the subordinate amount in step 854. Based on the computed amount, at step 856, the system allocates the WIPs first to existing subordinates. If anything remains, then, in step 858, the remaining WIP is allocated to existing supply (on hand or future). When the WIPs are in an ISR, the flow process is similar to that above. When the WIPs are in an ISR, the system must compute the subordinate amount 860. Based on the computed amount, at step 862, the system allocates the WIPs first to existing subordinates in tanks. If anything remains, then, in step 858, the remaining WIPs are allocated to existing supply (on hand or future). If the system determines replenishment is needed in step 866 (regardless of whether WIPs are in an ISR or not), the system will create a subordinate order in step 868.

As a result of the above netting logic for WIPs, each order has allocations to on-hand supply and scheduled receipts. Subordinates are created and associated to the parent order for the balance.

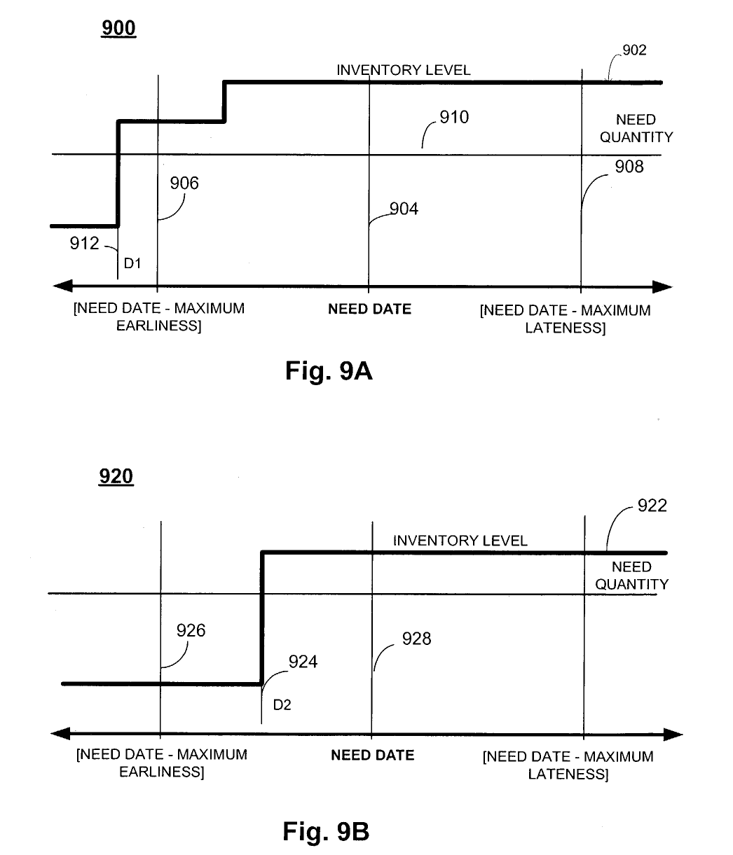

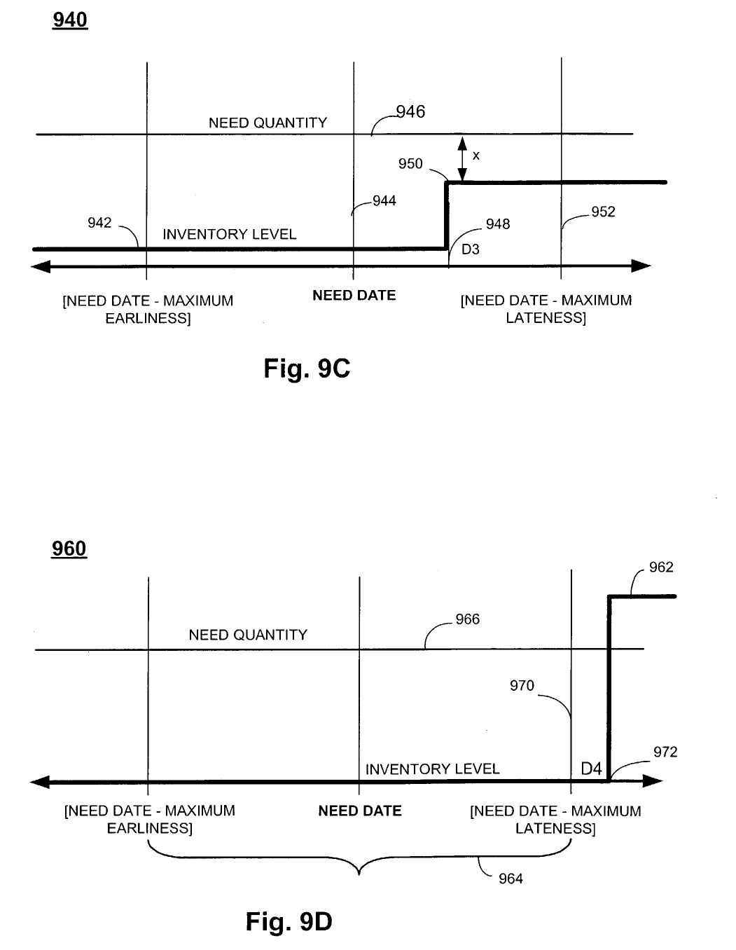

The netting logic may be further understood with reference to FIGS. 9A to 9D, which are exemplary timelines depicting inventory levels and need quantity over a period of time. FIG. 9A depicts inventory levels 902 rising during the early part of a timeline 900. The need date is depicting as a vertical line 904. The earliest acceptable date is indicated by a vertical line 906, which is equal to the need date minus maximum earliness. The latest acceptable date is indicated by a vertical line 908, which is equal to the need date plus maximum lateness. Thus, the time interval between vertical lines 906 and 908 is the acceptable time period. The need quantity is indicated by a horizontal line 910. Since, in this example, the inventory level 902 rises early in the timeline 900, the inventory available date D1 910 is before the earliest acceptable date 906. An inventory available date 912 is the date in which the inventory is at its maximum or the first date in which the inventory level exceeds or equals the need quantity. Therefore, in this timeline 900, the inventory needed is available from the earliest acceptable date 906. In a timeline 920 of FIG. 9B, an inventory level 922 rises much slower than the inventory level 902 of FIG. 9A. As a result, the inventory available date 924 is after the earliest acceptable date 926 but before the need date 928. Referring to FIG. 9C, which is another exemplary timeline 940. In this time line 940, an inventory level 942 rises even later in the timeline (after the need date 944) and never reaches a need quantity 946. An available inventory date 948 in this case will be earliest date in which the inventory is at its maximum (as indicated by 950) prior to a latest acceptable date 952. To make up the difference between the maximum inventory level 950 and a needed quantity 946, the inventory may be replenished and/or partially or fully substituted with alternative[s]. FIG. 9D is exemplary timeline when an inventory level 962 remains zero throughout an acceptable time period 964 and does not rise to a need quantity 966 until after a latest acceptable date 970 as indicated by the inventory available date D4 972.

Best tank heuristics: Best tank heuristics are employed in the netting process to find the best non-empty tank to satisfy an order. The system prefers a tank that has an initial SKU that covers the amount needed for an order. If the tanks have a minimum level defined, and if the tanks can be drained below that minimum level, the system will choose the best covering tank that drains below the minimum level the least. However, if there are not tanks with a defined minimum level that can cover, then the system will select the smallest existing tank that can cover. But if no single tank can cover, than the system will try to cover the need by choosing multiple tanks choosing from largest to smallest. Tank perturbation (discussed below) will not perturb scheduled receipt associations. The concept of tank perturbation is discussed further below.

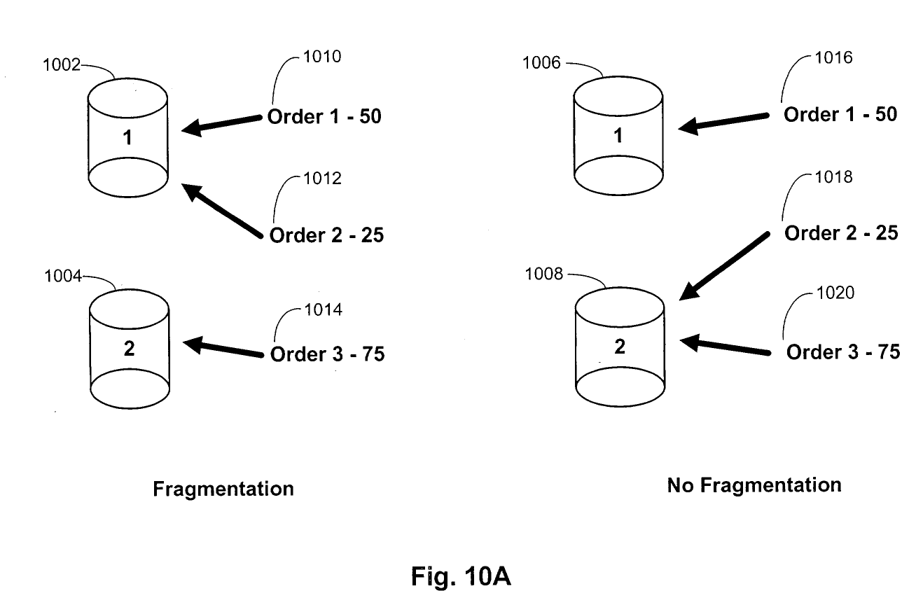

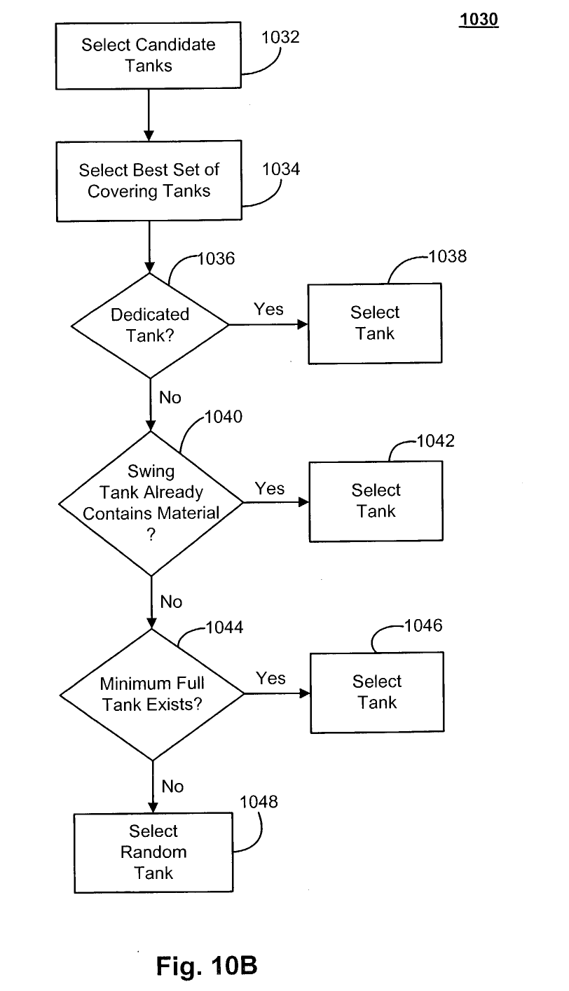

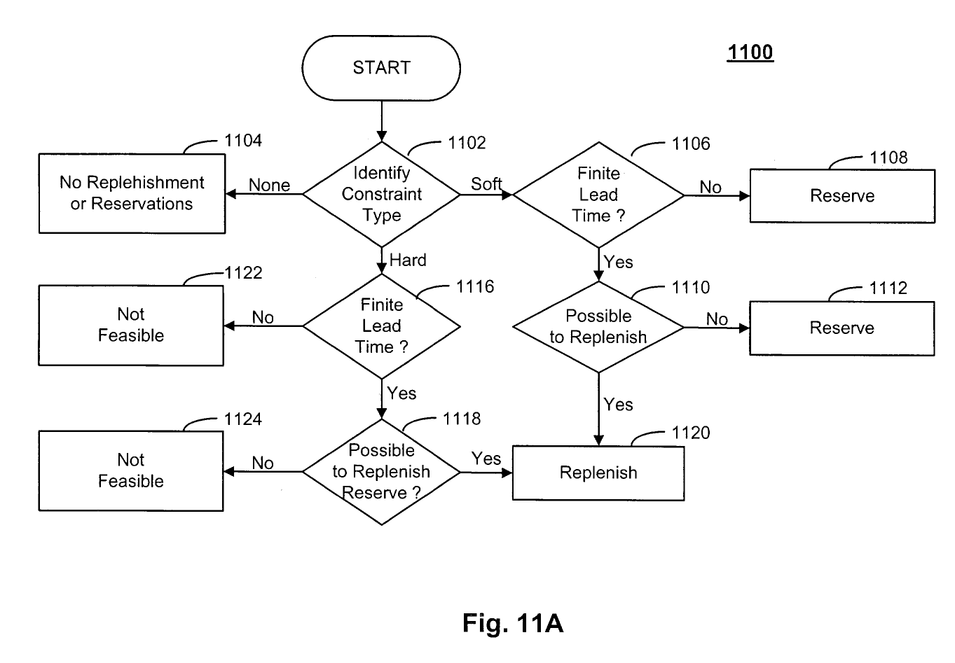

In employing best tank heuristics, fragmentation of resources can limit optimization. Using a greedy best fit method on tank contents, can result in more fragmentation than is ideal. When possible, one way to avoid excessive fragmentation is to combine the tanks. As shown in FIG. 10A, four tanks 1002, 1004, 1006, and 1008, each with capacity 100 units are used to supply three orders. In an example of fragmentation, orders 1010 with 50 units and 1012 with 25 units are filled from tank 1002; while an order 1014 with 75 units is filled from tank 1004. The result after filling the three orders is two partly filled tanks of 25 units each. In an example of a process with no fragmentation, an order 1016 with 50 units is filled from tank 1006; while an order 1018 with 25 units and an order 1020 with 75 units are filled from a tank 1008. The result after filling the three orders is one empty tank and one partially full tank of 50 units.

Tank optimization can also be compromised by issues with timing and gradual usage of tank contents. When an assignment is met by multiple supplies, the optimal timing depends on the rest of schedule. The system's behavior is to gradually use all supplies through the usage interval. In embodiments where there is no way to override this default behavior, subordinates may be delayed as long as material is feasible. Thus, in one embodiment of the invention, the scheduled receipt can be used first to free up the tank for other production. In another embodiment, the subordinate can be used first when another assignment needs production and there needs to be an assurance of no overfill.

Best tank heuristics are also employed to find the best empty tank for replenishment. As shown in FIG. 10B, the system determines the candidate tanks in step 1032, considering all tanks without a minimum level and, for tanks with a minimum level, considering the set of tanks that best achieves the minimum level. From the candidate tanks, the system, in step 1034, then finds the best set of covering tanks or the tanks that are the minimum under the level needed to cover. Next, in step 1036, the system will look for the most preferred tanks, which will be those dedicated to the material, and select that tank, if available in step 1038. A secondary preference is sought in step 1040 for those tanks that swing (i.e., can be used for more than one material) and already contain the required material. The system will select that tank, if available in step 1042. If a preferred tank is not available, the system will attempt to identify the minimum full tank in step 1044, and select that tank, if available in step 1046. However, if no preferred tanks or minimum full tanks are identified, the system will select tank at random in step 1048. The tank perturbation can choose alternate tanks, thus altering the default preferences.

Creating replenishments. Replenishments are accomplished according to a set of user-identified constraints. Constraints for replenishments can be defined as one of three types: hard, soft, or none. Hard-constrained material will never be infeasible with the modeling horizon. The system guarantees that this will be the case by using a material delay constraint that delays an assignment until all material is feasible. If the system cannot satisfy feasibility, this constraint delays the material until the horizon end. The system must stay within the initial state for the material. Orders that would cause the material to become infeasible are not scheduled. Finite lead-time materials can be replenished based on the replenishment model. Soft-constrained material can be infeasible. To avoid determination of infeasibility, the user can add a penalty for the amount of infeasible material in a schedule. No replenishments are allowed for infinite lead-time material. Finite lead-time materials can be replenished based on the replenishment model.

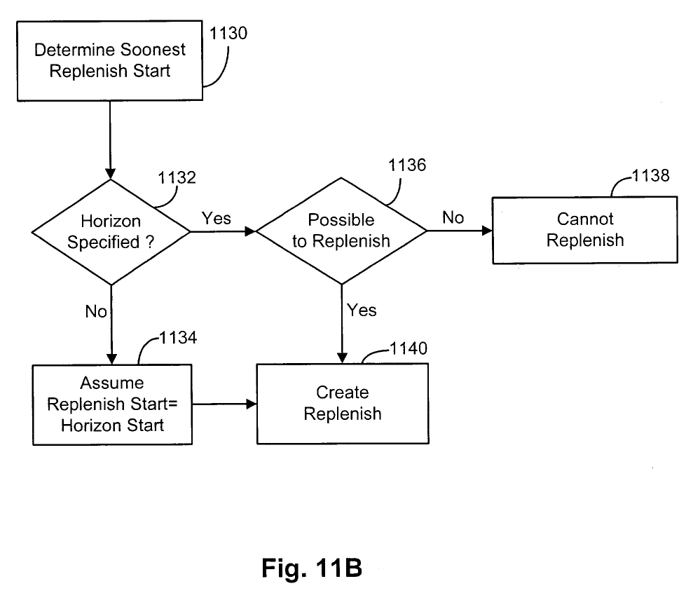

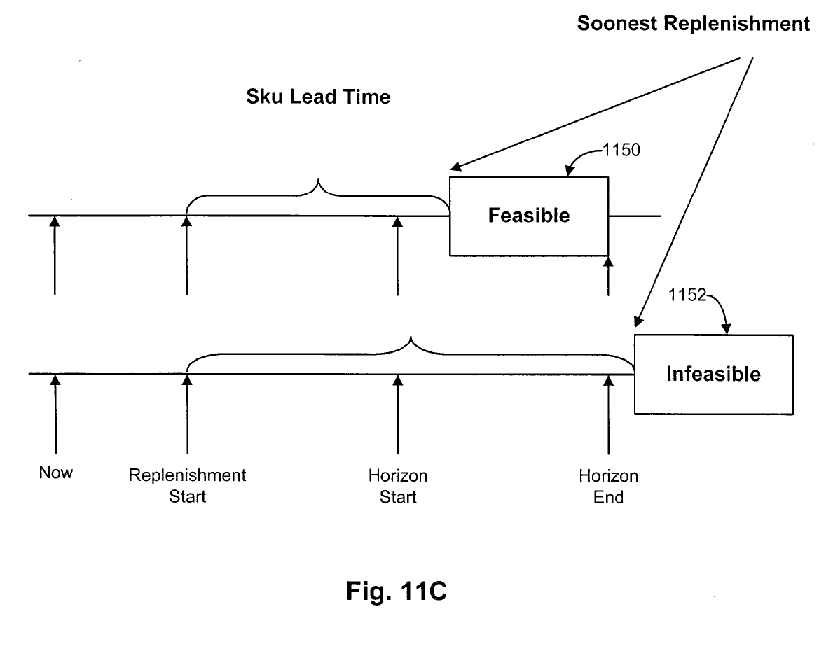

FIG. 11A shows a flow process for creating replenishments. As shown in FIG. 11A, when the system plans replenishment to support an order, it must first identify the type of constraint at step 1102. If none mode is identified, the system goes to step 1104 and does not consider replenishments. If hard constraint is identified, the system next looks to see if the lead time for replenishment is finite in step 1116. If the lead time is infinite, replenishment is deemed not feasible in step 1122. If the lead time is finite, the system checks, in step 1118, whether it is possible to replenish the reserve in time to support an order. If not, then replenishment is deemed not feasible in step 1124. If replenishment is feasible, then the system assigns replenishment in step 1120.

If a soft constraint is identified, the material on reserve may be allowed to go negative, providing more flexibility for creating replenishments. In step 1106, the system looks to see if the lead time for replenishment is finite. If not, then the system, in step 1108, writes assignments so that appropriate resources and/or materials that are needed to fulfill the orders may be reserved. If the lead time is finite, then the system checks in step 1110 whether it is possible to replenish the reserve in time to support an order. If possible, then the system will assign replacement in step 1120. If not possible, then the system will write assignments so that appropriate resources and/or materials that are needed to fulfill the orders may be reserved.

FIGS. 11B and 11C provide an overview of the decision sequence in determining whether it is feasible to replenish. At step 1130 the system determines the soonest replenishment start time which is equal to the replenishment start date plus the SKU lead time considering SKU effectivity. Next, in step 1132, the system looks to see if any horizon is specified. If so, and the soonest replenishment would be after the horizon end, as determined in step 1136, the system cannot replenish 1138. The infeasible replenishment scenario 1152 is shown in FIG. 11C. If a horizon is specified and the soonest replenishment would be before the horizon end, the system proceeds to step 1140 to create a replenishment. However, if the horizon is not specified, step 1134 assumes that the replenishment start is the horizon start and there is no end. Thus, in step 1140, the system creates the replenishment. The feasible replenishment scenario 1150 is shown in FIG. 11C.

In creating the replenishments at step 1140, if the SKU has a maximum reorder quantity or the replenishment is into a tank with capacity less than the replenishment quantity, multiple receipts will be created until the quantity is exactly met. Otherwise, one replenishment will be created for the entire quantity. No replenishment can occur before the SKU effective start time.

Synchronization of subordinates: A user of the system may specify that a SKU is synchronized. As part of subordinate generation, all assignments for synchronized SKUs will be associated with equal in time start relationships. These relationships will be handled in the queue scheduler. Sets of synchronized assignments are pulled forward if they are in the same route component to ensure no blocking. The actual queue layout is determined based on the particular route, route components, rate processing, and temporal relationships of the SKUs.

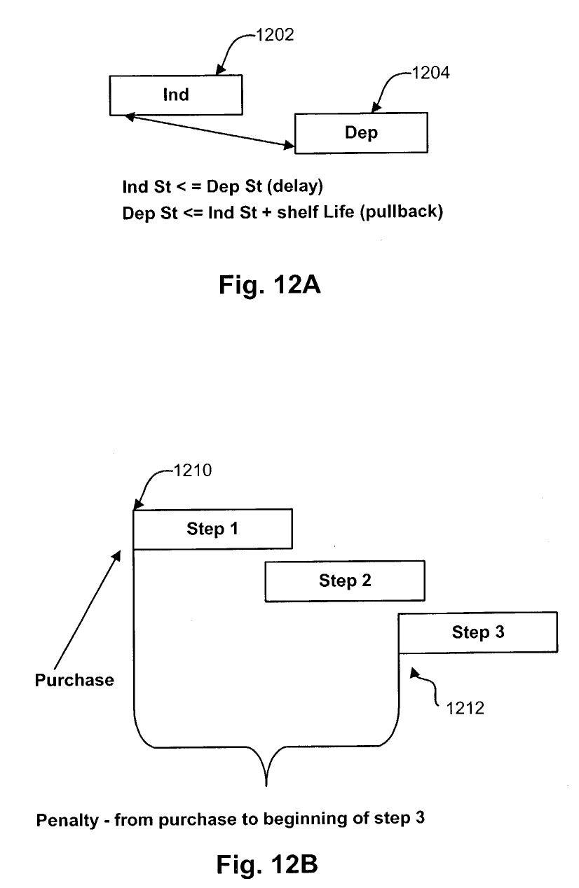

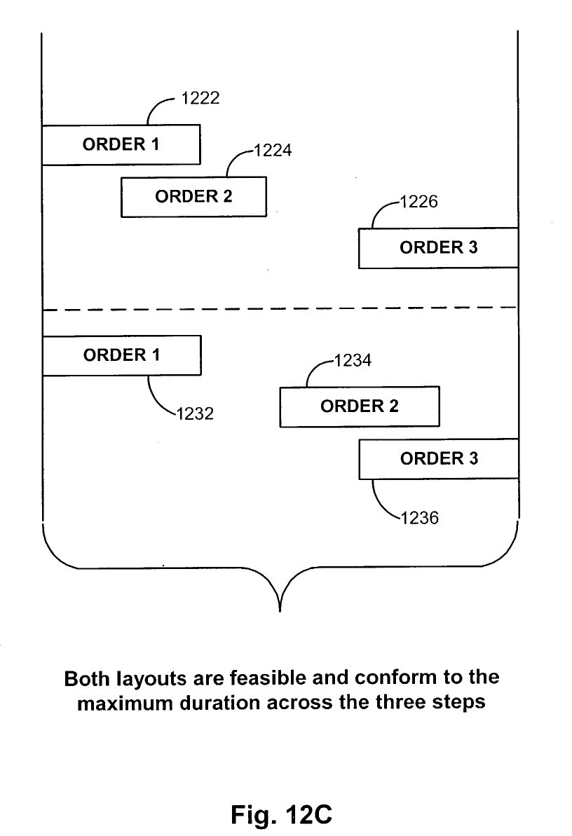

Shelf-life: Shelf-life of resources must also be factored into the netting process. Shelf-life can be modeled using step to step through pull-back relationships. If a SKU (finished good or WIP) is flagged as being subject to cycle time constraints, then the calculation is made on that total cycle time the beginning of the usage of the resource material to the time it is consumed. This may be more than two stages over which the calculation is made. Step to step pullbacks mean that the assignments are pulled in or pushed out to manage (reduce) the cycle time so that it is not penalized by the metrics defined. Shelf-life constraints may be defined as either hard or soft. FIG. 12A shows the relationship between two resources, an independent resource 1202 and a dependent resource 1204. If the start time of resource 1202 is before or equal to the start time of the dependent resource 1204 the dependent resource must be delayed. If the start time of resource 1204 is before or equal to the start time of the independent resource 1202 plus resource 1202's shelf life the order must be pulled back.

Shelf life through multiple steps with raw materials can be modeled across stages to get a total duration from the scheduled receipt/purchase/WIP to desired the user's stages. The system applies a penalty used to drive optimization to desired result. Thus the earlier a resource is purchased before it is needed, the greater the penalty score that will be included in the calculation. FIG. 12B depicts a penalty that would be applied where a purchase at the start of step 1210 results in shelf time until the start of step 1212. FIG. 12C represents two sets of scheduled steps that would both accepted by the system because they conform to the maximum duration as defined by the user. In this example, the first set of three orders—order1 1222, order2 1224, and order3 1226—and the second set of three orders—order1 1232, order2 1234, and order3 1236—are both completed within the maximum allowable duration as defined by the user. Thus, the fact that order2 1224 and order2 1234 are completed at different times, relative to the other orders, does not impact feasibility of the schedule.

Forward schedule coverage is used in the netting algorithm to create material once for multiple downstream uses. For example, 100 units of resource X may be purchased at an early point to supply order A requiring 75 units and order B requiring 25 units downstream. A demand conditioner in the system identifies opportunities for schedule coverage, creates quantities, jobs, dates, relationships between parents and subordinates.

Optimization. After the data for the production model has been netted into a functional model, the system allows the user to optimize the production schedule according to specific preferences. As part of the initial processing, the initial model includes a hard constrained SKU, because the system creates the constraint is automatically to ensure that assignments are delayed until material is feasible. The system contains a queue scheduler or regular scheduler that can be used to schedule around material problems. If schedule coverage, synchronized SKUs, or tanks are used, the queue scheduler is preferred.

Perturbations: Perturbations are used by the system to move from one possible solution to another. Perturbations have distinct names and weights and they can be restricted to only modify a given resource or all the resources within a group. The weights are a probability that the perturbation will be used to create the new solution. The representative perturbations considered in this invention can be divided into two types: general and heuristic boost. The heuristic boost perturbations are “smart” perturbations in that they have knowledge of the problem domain. General perturbations do not have this knowledge and merely move assignments from place to place. The perturbations discussed below are representative of those used in this invention, although other perturbations may be used without departing from the spirit of the invention.

The General Perturbations are described as follows:

PertOrderSwap—Pick two assignments on the same resource and swap them. The first assignment can be randomly picked or picked based on penalty. The second assignment can be randomly picked or picked based on matching SKU or attribute.

PertOrderSwapRs—Pick two assignments on two resources and exchange them. The product can be made on both resources. The first assignment can be randomly picked or picked based on penalty. The second assignment can be randomly picked or picked based on matching SKU or attribute.

PertOrderIns—Pick an assignment on a resource and insert it before or after another assignment on the same resource. First assignment can be randomly picked or picked based on penalty. Second assignment can be randomly picked or picked based on matching SKU or attribute.

PertOrderQty—Pick an assignment and move all or part to another resource. The assignment can be picked randomly or based on penalty. Entire quantity can be moved with a probability of 1.0. New assignment can placed randomly or next to another assignment with the same value for SKU or attribute.

PertRandSeq—Pick a random sequence on a resource and move it to the same or a different resource. Predefined attributes are used to determine if the sequence can be moved to a different resource. A 1.0 score equals a 100% probability of moving the sequence to another resource. The chosen sequence can be extended by SKU, group, or attribute, can be set to insert randomly or on the boundary of a SKU, group, or attribute run.

PertISR—Pick an ISR assignment and move it from one ISR to another.

The Heuristic Boost Perturbations are described as follows:

PertHBPRCap—Perturbation heuristic boost for adjusting the rates of assignments on the pooled reusable resource to fully utilize the rate of the pooled reusable resource.

PertHBAuxRate—Perturbation heuristic boost for adjusting rates of assignments using an auxiliary rate resource in order to close a gap due to rate usage or to raise rates towards maximum rates.

PertHBSort—Perturbation heuristic boost for temporal relationship sorting. Sorts assignments in temporal relationships in respect to the upstream assignments or downstream assignments.

PertHBTime—Perturbation heuristic boost for timeliness. Pick a late assignment randomly or based on a penalty and move it to a random earlier position on the same resource. This is good to use if trying to minimize the number of late jobs.

PertHBGap—Perturbation heuristic boost for filling a gap. Pick a random gap and pick a random assignment that can be made on that gap resource and try to put it into that gap. A probability can be set so that only late assignments are considered for the gap.

PertHBIso—Perturbation heuristic boost for moving isolated assignments. Locate isolated assignments with respect to SKU, attribute value, or changeover group, and moves it to matching assignments.

For example, the following could happen

A A A B B BA C C C→A A AA B B B C C C

The lone assignment A gets moved to join a group of A by using PertHBIso.

PertHBConsolidate—Perturbation heuristic boost for consolidating assignments according to SKU or attribute value. This perturbation picks a random assignment and consolidates the assignments on the resource with the same SKU or attribute.

PertHBQtySplit—Perturbation heuristic boost for splitting assignments within a processing group. Split or move quantities to fill a gap with respect to the primary assignment in a processing group. It is used to adjust quantities on processing group assignments if they are close to lining up but do not quite make it thereby causing a delay.

Metrics: Metrics are used by the system to add penalties for undesirable characteristics and to reward desirable characteristics. After the system has created a candidate schedule, it assigns a grade to the schedule based on the metrics defined in a metric table (or tables) defined by the user. The table[s] is where the user enters which characteristics of a schedule he wants to optimize to reach his desired schedule. For example, a user may want to minimize changeovers; or he may prefer to minimize late or early jobs. Other users may have resource utilization as an essential priority. There are many metrics that one can choose from and their choice depends on the specific problem one is trying to solve. More than one metric can be defined and weights can be assigned to them to make some metrics worth more than others in the grading scheme. The more metrics that are defined, the slower the optimizer will run. Therefore, only those metrics that are most pertinent to the problem should be defined. A representative set of metrics that can be used with the present invention is defined below, although other metrics may be used without departing from the spirit of the invention.

Schedule span metrics.

MetricMaxSpan—The largest span in days across all resources. Good when load balancing is not an objective. Thus a penalty for this metric equals MaxSpan, which equals (Latest end for all resources in the group—earliest start for all resources in the group).

MetricMaxAvgSpan—The largest span in days across all resources plus the deviations from the average. Good when load balancing is the objective. Thus, a penalty for this metric equals the MaxSpan plus the sum of deviation around average for a particular resource, where the deviation around average for resource A equals the absolute value of (average span for all resources in the group−span for resource A). For example, given three resources with the following spans: A=10, B=20, C=30; the maximum span is 30, the average span is 20, and the deviations are A=10, B=0, and C=10. The penalty=(maxSpan) 30+(sum of deviation) (10+10)=50.

Changeover Metrics. Changeover metrics can be used to minimize change duration, changeover cost, and number of changeovers in the schedule. Changeover models have to be defined in the model in order to use these metrics.

MetricTotChgDur—Add the total time (in days) spent in changeovers across resources in the group as a penalty. It is used to prefer no changeovers over a changeover and a shorter changeover over a longer changeover. Thus, a penalty for this metric equals the total time in days spent in changeovers.

MetricAvgChgDur—Add the average time (in days) spent in changeovers across the resources in the group as a penalty. It is used to prefer no changeovers over a changeover and a shorter changeover over a longer changeover. Thus, a penalty for this metric equals total time in days spent in changeovers divided by the number of resources which have changeover models.

MetricTotChgCost—Add the total changeover cost across resources as a penalty. It is used to prefer no changeover over a changeover and a low cost changeover over a high cost changeover. Thus a penalty for this metric equals the total changeover cost across resources.

MetricAvgChgCost—Add the average changeover cost across resources as a penalty. It is used to prefer no changeover over a changeover and a low cost changeover over a high cost changeover. Thus a penalty for this metric equals the total changeover cost across resources divided by the number of resources which have changeover models.

MetricTotChgsNum—Add the total number of changeovers across resources as a penalty. It is used to reduce the number of changeovers in the schedule and does not care how long the changeovers are. Thus a penalty for this metric equals the total number of changeovers across resources.

MetricAvgChgsNum—Add the average number of changeovers across resources as a penalty. It is used to reduce the number of changeovers in the schedule and does not care how long the changeovers are. Thus, a penalty for this metric equals the total number of changeovers divided by the number of resources.

Order Lateness/Earliness Metrics. The system uses these metrics to control the earliness and lateness of the orders in the schedule. Typically, customer models have to be defined in a metric table. The customer model is used to determine whether an order is late or early and the multiplier to use (possibly non-linear) for lateness or earliness. Initial assignments cannot be early or late.

MetricNumEarlyOrders—Add the total numbers of early orders as a penalty. A penalty for this metric equals the total number of early orders.

MetricNumLateOrders—Add the total number of late orders as a penalty. A penalty for this metric equals the total number of late orders.

MetricTotEarliness—Add the total earliness in days as a penalty. A penalty for this metric equals the sum of (order earliness in days*priority). For example, particular order A is early by 2 days with priority of 1 and order B is early by 3 days with priority of 5. Thus, a penalty of 2*1+3*5=17 would be assigned.

MetricTotLateness—Add the total lateness in days as a penalty. A penalty for this metric equals the sum of (order lateness in days*priority*a customer lateness penalty (CLP)). CLP is the number of lateness periods to the power of a lateness factor. Thus, the system uses CLP to give a non-linear penalty.

Calendar metric.

MetricAttrCal—MetricAttrCal is used to make matching jobs scheduled at allowed times by adding penalties when they overlap down times. A penalty for this metric equals the sum of (number of minutes scheduled within a period of unavailability for a matching order). For example, order A is scheduled in an unavailable area with duration of 20 minutes, and order B is scheduled in an unavailable area with duration of 30 minutes. Since both orders match the criteria, the penalty=20+30=50.

Pooled Reusable Resource Utilization Metric.

MetricPRCap—MetricPRCap is used to add penalties based on the pooled reusable resource utilization. If a user wants to maximize the utilization of the pooled reusable resource, set the definition so that any availability of the pooled reusable resource will be penalized. A penalty for this metric equals the duration in days*availability below or above the threshold. For example, if available capacity is 0.3 for day one and two, and available capacity is 0.2 for day three, the penalty=2*(0.3−0.0)+1*(0.2−0.0)=0.8.

Auxiliary Resource Utilization Metric.

MetricAux—MetricAux is used to add penalties based on the auxiliary resource utilization. If a user wants to maximize the auxiliary resource utilization, set the definition so that any availability of the auxiliary resource will be penalized. A penalty for this metric equals the duration in days*availability below or above the threshold. For example, if available capacity is 3 for day one and two, and available capacity is 2 for day three, the penalty=2*(3−0)+1*(2−0)=8.

Material Utilization Metric.

MetricMat—MetricMat is used to add penalties based on the material utilization. A penalty for this metric equals the duration in days*availability below or above the threshold. For example, given that material availability for day one is −20.0; material availability for day two and three is −30.0; and material availability for day four is 10.0; the penalty=1*(0.0−(−20.0))+2*(0.0−(−30.0))=80.0.

SKU Cycle Time Metric.

MetricSkuCycleTime—This metric is used to add penalties for excessive cycle times on a SKU. The maximum SKU cycle time can be defined by the user. It is measured from the time a SKU starts being used until a stage or the finished good is ready. The time a SKU starts being used can be the start time of a scheduled receipt or a purchase, the OHPost of a SKU, or the start time of an assignment. A penalty for this metric equals the sum of (actual SKU cycle time in days−maximum SKU cycle time in days).

Resource Preference Metric.

MetricRsPref—This metric adds a penalty for assignments on resources that are not preferred. Resource preferences are specified in the user by SKU, with 0 meaning most preferred, 1 meaning next preferred, etc. For example, a factory may have certain lines that do a better job than the other lines. A user can use this metric to make sure the most efficient lines are used. A penalty for this metric equals the preferred value*weight. For example, if an assignment is on a next preferred resource with preferred value set to 1, and the metric weight is 10; the penalty=1*10=10.

Rate Utilization Metric.

MetricMinRate—This metric adds a penalty for assignments that are running at less than the desired rate. The desired rate can be minimum rate, nominal rate, or maximum rate, which can be defined by the user. This metric can be used to enforce the assignment to run at a desired rate or faster. A penalty for this metric equals the (desired rate/assignment rate which is less than the desired rate)*weight. For example, if the desired rate is 2.0 (nominal rate), and assignment A is running at rate 2.5, and assignment B is running at rate 1.5; there is no penalty for assignment A and the penalty only applies to assignment B. Assuming the weight is 10, the penalty=2.0/1.5*10=13.3.

Temporal Relationship Metric.

MetricTempRel—This metric adds a penalty whenever a temporal relationship is not met. Temporal relationships are defined by the user. A penalty for this metric equals the difference*weight. The difference is measured in seconds. Weight can be used to adjust the penalty that contributes to the final grade.

SKU Cost Metric.

MetricSkuCost—This metric can be used to reduce the material cost. SKU cost can be defined by the user. For the orders that are scheduled within the horizon, a penalty for this metric equals the SchRcptQty*SkuCost+MatAsgQty*SkuCost. SkuCost is defined by the user. SchRcptQty is the quantity of the scheduled receipt. MatAsgQty is the quantity of the material that are consumed and the finished good.

Transportation Cost Metric.

MetricTrans—This metric adds a penalty to go from the factory location to the customer location. A penalty for this metric equals the transportation cost from a factory location to a customer location.

Load Metric.

MfgLoad—This metric adds a penalty for the order which is outside of the load horizon and exceeds the threshold. It is used to minimize the cycle time for finished goods that are in the same load. A penalty for this metric equals the distance in days*load penalty*weight. The load penalty is defined by the user. Distance is the distance that the order is out side of the load horizon. If it is inside the load horizon, the distance is zero and there is no penalty.

ISR Choice Metric.

MetricISRChoice—This metric will penalize each fill that chose the wrong ISR. If the assignment quantity is less than both tanks and the alternate tank is smaller then the current tank, penalize. Note that if there are multiple alternate tanks, we penalty the smallest amount. If the assignment quantity is greater than both tanks and the alternate tank is greater then the current tank, penalize. A penalty for this metric equals the capacity difference*weight. For example, if the order quantity=15, and the current ISR capacity=10, and the alternate ISR capacity=12; then the penalty=(12−10)*weight.

ISR Number Metric.

MetricISRNum—This metric will penalize the total number of ISR used in the scheduling horizon. A penalty for this metric equals the total number of ISR used in the scheduling horizon.

Preferred Area Metric.

MetricPrefArea—This metric adds a to the orders that are not scheduled in the preferred area. Each SKU has an optional preferred area which can be defined by the user. A penalty for this metric equals the number of assignments not in the preferred area for each order*the number of areas for each order*weight. For example, order 0 is scheduled in area AX, AY, and AZ, with AX as the preferred area. The number of assignments not in the preferred area=2, and the number areas for the order=3. Thus, the penalty=2*3*weight.

Order Slot Preference Metric.

MetricOrdSlotPref—This metric adds a penalty if the order is not scheduled in the preferred slots. The start slot and end slot for an order can be defined by the user. A valid slot number is greater than zero. This metric can be used for both time based scheduling and slot based scheduling. A penalty for this metric equals the distance to the preferred slots*weight. For example, if the preferred start slots is 3 and preferred end slots is 5, this means that slots 3, 4, and 5 are preferred. If the order is scheduled at slot 7, the penalty=(7−5)*weight.

Buffer Metric.

MetricBuffer—This metric applis penalties whenever a static buffer is overfilled between two stages. The penalties are calculated and applied to the output of the buffer, not the input. A buffer is an area between two stages where things can be rearranged and stored. It is usually modeled when there is a finite amount of storage available. The user can specify a buffer length and penalties are added whenever a schedule causes the buffer to be overfilled. A penalty for this metric equals the buffer used buffer−length if the buffer used is greater than the buffer length.

Excess Metric.

MetricExcess—This metric minimizes the amount of excess made due to batch minimum or increments. A penalty for this metric equals the duration in days to make the excess quantity.

Resource Utilization Metrics.

MetricTotUtilTime—This metric adds the total utilization time in days on individual resources as a penalty. It can be used to enforce the fast resource to be used instead of slow resource. A penalty for this metric equals the total utilization time in days.

MetricTotIdleTime—This metric adds the total idle time in days on resources as a penalty. It can be used to reduce the total amount of idle time in the schedule. A penalty for this metric equals the total idle time in days.

MetricTotUtilCost—This metric adds the total utilization cost for individual resources and auxiliary resources as a penalty. It can be used to enforce the low cost resources to be used instead of high cost resources. Resource utilization cost is defined by the user. A penalty for this metric equals (the utilization duration in days)*(utilization cost).

MetricTotIdleCost—MetricTotIdleCost adds the total idle cost as a penalty. It can be used to get rid of gaps on high cost resources at the expense of gaps on low cost resources. Resource idle cost can be defined by the user. A penalty for this metric equals (the resource idle time in days)*(resource idle cost).

MetricTotUtilNum—This metric adds the total number of assignments on individual resources as a penalty. It can be used to reduce the number of assignments in the schedule especially if assignments can be split. It does consider the duration of each assignment. A penalty for this metric equals the total number of assignments on individual resources in the schedule.

MetricTotIdleNum—This metric adds the total number of gaps on individual resources as a penalty. Can be used to reduce the number of gaps. But it does not consider the length of each gap. A penalty for this metric equals the total number of gaps on individual resources.

Gap Metric (MetricAttrGap). With this metric type, the user can define four different kinds of metrics by using the metric specific attributes. However, only one type can only be used at a time.

Minimum Gap Metric—For this metric, penalties are applied when like assignments are too close. A penalty for this metric equals the (MinGapLength−CurGapLength)*MinGapPenalty*2, where MinGapLength is defined by the user.

Maximum Gap Metric—For this metric, penalties are applied when there are too many assignments between the like assignments. A penalty for this metric equals the (CurGapLength−MaxGapLength)*MaxGapPenalty*2.0, where MaxGapLength is defined by the user.

Desired Gap Metric—For this metric, penalties are applied when there are too many or too few assignments between like assignments. A penalty for this metric equals the absolute value of CurGapLength−DesiredGapLength*DesiredPenalty *2.0, where DesiredGapLength is defined by the user.

Globally Spread Metric—This metric is used to globally spread assignments with a user specified SKU attribute description. A penalty for this metric equals the absolute value of (CurGapLength−DesiredGapLength)*DesiredPenalty*2.0, where DesiredGapLength is defined by the user.

Run Metric (MetricAttrRun). With this metric type, the user can define three different kind of metrics by using the metric specific attributes. However, you can only use one type at a time.

Minimum Run Metric—For this metric, penalties are applied when the minimum run length for the like assignments is not achieved. A penalty for this metric equals the (MinRunLength−CurRunLength)*MinRunPenalty, where MinRunLength is defined by the user.

Maximum Run Metric—For this metric, penalties are applied when the run for the like assignments exceeds the maximum run length. A penalty for this metric equals the (CurRunLength−MaxRunLength)*MaxRunPenalty, where MaxRunLength is defined by the user.

Desired Run Metric—For this metric, penalties are applied when there are too many or too few assignments for the like assignments in a run. The user defines DesRunLength and DesRunPenalty to define this metric. If DesRunLength is less than or equal to zero and DeRunPenalty is greater than zero, the system will calculate the desired run length. It will be the number of matching orders in the model. A penalty for this metric equals the absolute value of (CurRunLength−DesRunLength)*DesRunPenalty.

Follow-on Gap Metric.

MetricAttrFollow—This metric works like the gap metric type above, but a user can specify the type of “from” assignment and “to” assignment to model asymmetric constraints. The system can constrain minimum, desired, and maximum gaps between occurrences of assignments. The assignments are divided into ‘To’ assignments and ‘From’ assignments. Penalties are assessed whenever a ‘From’ assignment follows a ‘To’ assignment and does not obey the gap constraints. A penalty for this metric equals the difference from the specified gap length*rule penalty*weight*2.0.

Per N Order Metric.

MetricAttrPerNOrds—With this metric, the system constrains the number of matching orders in a moving slot window. The minimum, desired, or maximum number of matching orders can be specified. The user can specify the starting/ending index and the number of windows. A penalty for this metric equals the (difference from the specified number orders)*rule penalty*weight.

Split Index Metric.

MetricSplitIx—With this metric, the system makes matching orders schedule either before or after a given index in a rolling window. If the user specifies before, occurrences should be on or before the given index. If the user specifies after, occurrences should be on or after the given index. A penalty for this metric equals the distance from the split index*rule penalty*weight.

Max Area Metric.

MetricAttrMaxArea—This metric adds a penalty whenever the number of areas that the orders with the same attribute value are scheduled exceed the maximum. The metric can be used to reduced the number of areas that are used to schedule the orders with the same attribute value. A penalty for this metric equals the number of areas minus the maximum number of areas.

Order Need Date Sequence Metric.

MetricAttrOrdOrder—With this metric, the system makes matching assignments schedule in the order of their need date. A penalty is added on each resource whenever an assignment for a later order is scheduled before an assignment for an earlier order. A penalty for this metric equals the (previous order's need date−current order's need date) in seconds*weight.

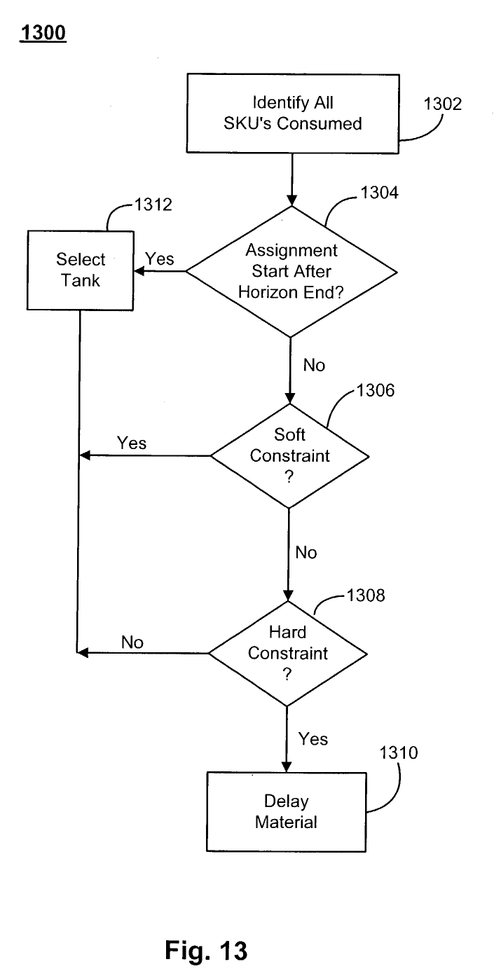

Once any independent assignments that fill tanks/create WIPs have been scheduled, the user may seek to schedule an assignment. FIG. 13 represents the process flow when considering delays for material. First the system will identify all the SKUs consumed for the relevant orders in step 1302. The system then looks to the assignment start time at step 1304. If the assignment start time is after the horizon end time, then no delay is necessary and the system, in step 1312, selects a tank. If the assignment start occurs before the horizon end, the system next checks to determine if there is a constraint on the material at step 1306. If the material has a soft constraint, then no delay is necessary and the system, in step 1312, selects a tank. If the material has no soft constraint, the system looks for a hard constraint in step 1308. If the material is found at step 1308 to include a hard constraint, then a delay may be assigned. Otherwise, no delay is necessary and the system, in step 1312, selects a tank.

When scheduling an assignment that reserves capacity and materials, the system updates states based on usage relative to the actual placement. Also tanks may require multiple purchases. They are placed feasibly JIT in case of multiple users.

Post Processing: After a schedule has been generated for an order, the system includes a post-processing capability to ensure availability and optimal use of remaining resources. One post-processing function involves generic storage of remaining materials. The system evaluates all material purchases from earliest to latest. For each purchase the system ensures current purchase is feasible (e.g., conforming to minimum/maximum order size and allowable increments). If a purchase greater than maximum, it can be split so that the excess is carried over excess and applied to next purchase (if shelf life tolerance is not exceeded). If a resource falls below the reorder point, the system will pull a purchase forward if possible and/or generate a purchase otherwise.

Another post-processing function involves ISRs. The replenishment of materials may be constrained by period maximums. Period maximums are used when a user cannot get all of the material the user wants in a given time frame. This can occur with commodity products such as iron ore or materials in high demand such as silicon. The user, for example, may get an allocation of no more than 10 tons in a week. In this case, the user needs to determine how to use these materials to make the most money. Within any applicable period maximum constraint, tank capacity drives the maximum receipt size for the ISR. The reorder point is triggered from the tank minimum level.

Given that the material allocation algorithm assigns material and creates replenishments before the schedule is generated, for assignments at the end of the scheduling horizon, material will not synchronized. A post-processing step is added that adjusts the created scheduled receipts to match the material in each period relative to the maximum amounts possible.

After the system has applied the algorithms to the model and optimized the model according to the user preferences a solution can be generated. Tables can be created, for example, for assignments, metrics applied, violations, and purchases. The user may define the particular format or display of the output tables. Additional sorting of user defined subgroups within the output tables is also contemplated.

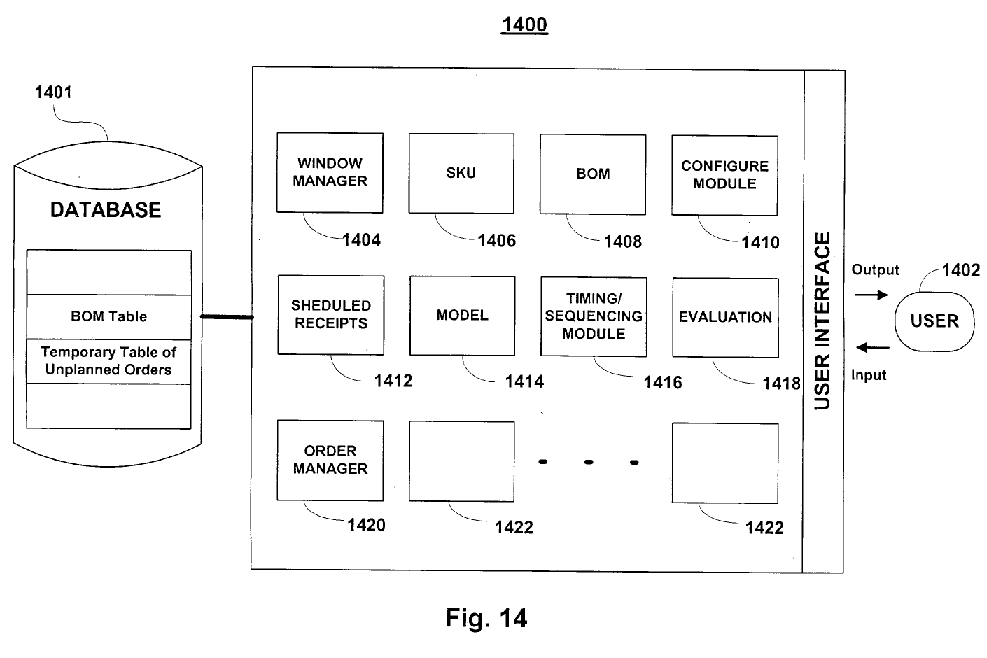

In one embodiment the system is implemented using a computer server attached to a database. FIG. 14 depicts an example of a system 1400 according to the present invention. A plurality of users 1402 and 1404 input information into database 1410 that stores the user inputs used to create a static model.

Referring now to FIG. 14, which is a block diagram depicting the sequencing system according to one embodiment of the present invention. The systeml400 may include a computer device such as personal computers, workstations, servers or any other devices having a microprocessor. The system 1400 may include a database 1401 which may comprise of a number of tables including a temporary table for unplanned orders, BOMs, configurations, orders, and the like. The system 1400 receives inputs from user[s] 1402 and generates planning outputs. The system 1400 may comprise a number of modules 1404 to 1422 to provide a number of functionalities. For example, the system 1400 may include a window manager module 1404 for managing an order window. The module 1404 may be use to organize and manage the order window. For example, window manager module 1404 may select the orders that are to be placed in to a window and prioritize those orders in the window. It may then be used to select the highest priority order for planning purposes. The SKU module 1406 may be used to organize, maintain, process and manage SKUs. Similarly, the BOM, configuration and scheduled receipt modules 1408 to 1412 are used to create, process and manage BOMs, configurations and scheduled receipts, respectively. The model module 1414 is used to create and manage models, which may be defined by the network resources, constraints and business rules, and the like. The time/sequencing module 1416 maybe used to create timelines and determine, process and manage timing events and time items. The evaluation module 1418 is used to evaluate and selecting various alternatives that may arise during the process according to the present invention. For example, the module 1418 may evaluate alternative opportunities, to evaluate alternative configurations, and the like. An order module 1420 for reviewing and parsing the data of an order. Based on the above descriptions, those skilled in the art will recognize that a number of other modules 1422 may also be included in the system 1400. These may include, for example, modules for managing and implementing business rules, searching goals, multi-level object function, and the like. Accordingly, the process and system in accordance with one embodiment of the present invention may be implemented using a combination of both software and hardware.

It will be apparent to those skilled in the art that various modifications and variations can be made in the system of the present invention without departing from the spirit or scope of the invention. Thus, it is intended that the present invention covers the modifications and variations of this invention provided that they come within the scope of any claims and their equivalents.

What is claimed:

1. A method for scheduling and sequencing use of resources to satisfy demand as defined by a group of orders, comprising the steps of:
creating a static model of a production environment;
placing initial assignments and allocating resources for said initial assignments;
selecting a subgroup of orders to plan;
prioritizing each order within said subgroup;
recursively identifying a highest priority order within said subgroup and processing each said highest priority order; and
writing at least one assignment for said orders with said subgroup.

2. The method according to claim 1, further comprising the step of creating a temporary table of unplanned orders.

3. The method according to claim 2, further comprising the step of unloading for reassignment dynamic data in said temporary table.

4. The method according to claim 1, wherein said static model comprises horizon data, SKU and order information, scheduled receipts, and initial assignments.

5. The method according to claim 4, wherein said static model further comprises bill of material information.

6. The method according to claim 4, wherein said horizon data includes scheduling horizons and material horizons.

7. The method according to claim 4, wherein said SKU and order information includes replenishment type, SKU usage data, and auxiliary usage data.

8. The method according to claim 7, wherein said replenishment type is at least one of lot-for-lot replenishment, absolute time based replenishment, relative time based replenishment, quantity based replenishment, and mixed models replenishment.

9. The method according to claim 7, wherein said replenishment type includes period maximum replenishment.

10. The method according to claim 7, wherein said replenishment type is based on minimum tank levels.

11. The method according to claim 7, wherein said SKU usage is at least one of gradual, instantaneous, and start/end synchronized.

12. The method according to claim 1, wherein said identifying and processing step includes the steps of netting, optimization, and post processing.

13. The method according to claim 12, wherein said netting step includes netting of at least one of orders, raw materials and work-in-progress.

14. The method according to claim 12, wherein said netting step comprises utilization of best tank heuristics.

15. The method according to claim 12, wherein said optimization step comprises utilization of perturbations.

16. The method according to claim 15, wherein said perturbations are either general or heuristic boost type perturbations.

17. The method according to claim 12, wherein said optimization step comprises utilization of user-defined metrics to evaluate a schedule of orders.

18. The method according to claim 1, wherein said method is implemented by a computer.

19. The method according to claim 1, wherein said initial assignments are used to reserve a resource for fulfilling a particular order before beginning said prioritizing step.

20. A system for scheduling and sequencing the use of resources to satisfy demand as defined by a group of orders, comprising:
means for creating a static model of a production environment;
means for placing initial assignments and allocating resources for said initial assignments;
means for selecting a subgroup of orders to plan;
means for prioritizing each order within said subgroup;
means for recursively identifying a highest priority order within said subgroup and processing each said highest priority order; and
means for writing at least one assignment for said orders with said subgroup.

21. The system according to claim 20, further comprising the step of creating a temporary table of unplanned orders.

22. The system according to claim 21, further comprising the step of unloading for reassignment dynamic data in said temporary table.

23. The system according to claim 20, wherein said static model comprises horizon data, SKU and order information, scheduled receipts, and initial assignments.

24. The system according to claim 23, wherein said static model further comprises bill of material information.

25. The system according to claim 23, wherein said SKU and order information includes replenishment type, SKU usage data, and auxiliary usage data.

26. The system according to claim 20, wherein said identifying and processing step includes the steps of netting, optimization, and post processing.

27. The system according to claim 26, wherein said netting step includes netting of at least one of orders, raw materials and work-in-progress.

28. The system according to claim 26, wherein said netting step comprises utilization of best tank heuristics.

29. The system according to claim 26, wherein said optimization step comprises utilization of perturbations.

30. The system according to claim 26, wherein said optimization step comprises utilization of user-defined metrics to evaluate a schedule of orders.

31. A system for scheduling and sequencing the use of resources to satisfy demand as defined by a group of orders, comprising:
a model module for creating a static model of a production environment;
an initial assignments module for allocating resources for said initial assignments;
a subgroup selection module for selecting a subgroup of orders to plan;
a prioritization module for prioritizing each order within said subgroup;
a priority module for recursively identifying a highest priority order within said subgroup and processing each said highest priority order; and
an assignment for writing at least one assignment for said orders with said subgroup.

32. The system according to claim 31, further comprising a module for creating a temporary table of unplanned orders.

33. The system according to claim 32, further comprising a module for unloading for reassignment dynamic data in said temporary table.

34. The system according to claim 31, wherein said model module comprises horizon data, SKU and order information, scheduled receipts, and initial assignments.

35. The method according to claim 34, wherein said model module further comprises bill of material information.

36. The method according to claim 34, wherein said SKU and order information includes replenishment type, SKU usage data, and auxiliary usage data.

37. The method according to claim 31, wherein said priority module includes a sub-module for netting, optimizing, and post processing information related to orders.

38. A program storage device readable by a machine, tangibly embodying a program of instructions executable by a machine to perform the steps of scheduling and sequencing the use of resources to satisfy demand as defined by a group of orders, comprising the steps of:
creating a static model of a production environment;
placing initial assignments and allocating resources for said initial assignments;
selecting a subgroup of orders to plan;
prioritizing each order within said subgroup;
recursively identifying a highest priority order within said subgroup and processing each said highest priority order; and
writing at least one assignment for said orders with said subgroup.

39. The program storage device according to claim 38, further comprising the step of creating a temporary table of unplanned orders.

40. The program storage device according to claim 39, further comprising the step of unloading for reassignment dynamic data in said temporary table.

41. The program storage device according to claim 38, wherein said static model comprises horizon data, SKU and order information, scheduled receipts, and initial assignments.

42. The program storage device according to claim 41, wherein said static model further comprises bill of material information.

43. The program storage device according to claim 41, wherein said horizon data includes scheduling horizons and material horizons.

44. The program storage device according to claim 41, wherein said SKU and order information includes replenishment type, SKU usage data, and auxiliary usage data.

45. The program storage device according to claim 44, wherein said replenishment type is at least one of lot-for-lot replenishment, absolute time based replenishment, relative time based replenishment, quantity based replenishment, and mixed models replenishment.

46. The program storage device according to claim 44, wherein said replenishment type includes period maximum replenishment.

47. The program storage device according to claim 44, wherein said replenishment type is based on minimum tank levels.

48. The program storage device according to claim 44, wherein said SKU usage is at least one of gradual, instantaneous, and start/end synchronized.

49. The program storage device according to claim 38, wherein said identifying and processing step includes the steps of netting, optimization, and post processing.

50. The program storage device according to claim 49, wherein said netting step includes netting of at least one of orders, raw materials and work-in-progress.

51. The program storage device according to claim 49, wherein said netting step comprises utilization of best tank heuristics.

52. The program storage device according to claim 49, wherein said optimization step comprises utilization of perturbations.

53. The program storage device according to claim 52, wherein said perturbations are either general or heuristic boost type perturbations.

54. The program storage device according to claim 49, wherein said optimization step comprises utilization of user-defined metrics to evaluate a schedule of orders.

55. The program storage device according to claim 38, wherein said initial assignments are used to reserve a resource for fulfilling a particular order before beginning said prioritizing step.

56. A method for scheduling and sequencing the use of resources to satisfy demand as defined by a group of orders, said orders having attribute data, comprising the steps of:
defining parameters of each of said orders;
associating one or more configurations to each of said orders based on a set of constraints;
defining subgroups of orders based on said configurations;
prioritizing each of said orders within said subgroups based on at least one of said configurations;
selecting a highest priority order from within said subgroup based on said priority of each said orders; and
planning use of a resources for fulfilling said selected highest priority order based on said configuration associated with said selected highest priority order.

57. A system for sequencing the use of supply chain manufacturing resources in order to fulfill a demand as defined by a group of one or more orders, comprising:
a sequencing server;
a database in communication with said computer server;
a module for defining orders by attributes;
a module for creating stock keeping unit groups, said groups being defined by attributes and associated with at least one order based on said groups' attributes;
a module for prioritizing said orders based on at least one of said groups;
a module for loading into a window at least one of said orders based on said priority of said orders;
a module for associating loaded orders to configurations;
a module for selecting highest priority order from said window based on said priority of said loaded orders; and
a module for selecting a resource for fulfilling said selected highest priority order based on said configuration associated with said selected highest priority order.

58. A program storage device readable by a machine, tangibly embodying a program of instructions executable by a machine to perform method steps of planning the use of manufacturing network resources to fulfill demand as defined by multiple orders by prioritizing and sequencing the orders according to their assigned priority, the method steps comprising:
organizing said orders into groups, said orders having at least two attributes;
prioritizing each group;
prioritizing each order within each said group based on attributes of each said order;
associating one or more configurations to each of said orders; and
sequencing the use of at least one of said resources in order to fulfill said demand, said sequencing is by planning for higher priority orders first before planning for lower priority orders based on priority of each group and priority of each order in each said group, and using said configuration associated with each order in order to select at least one of said resources for use in order to fulfill said demand.
